(19) United States
(12) Patent Application Publication
(10) Pub. No.: US 2019/0334328 A1
(43) Pub. Date: Oct. 31, 2019

(54) METHOD FOR PERFORMING UNINTERRUPTIBLE POWER DISTRIBUTION WORK WITHIN SECTION IN DE-ENERGIZED LINE STATE BY SEPARATING WIRES WITHIN POLE-TO-POLE SPAN BY MEANS OF INSULATED LIVE WIRE GRIP AND BYPASS JUMPER CABLE

(71) Applicants: DAEWON ELECTRIC CO.,LTD., Chungcheongbuk-do (KR); WOCHANG ELECTRIC POWER CO., LTD., Chungcheongbuk-do (KR); SEDAE ELECTRIC CO.,LTD., Chungcheongbuk-do (KR)

(72) Inventor: Sae Won KWON, Chungcheongbuk-do (KR)

(21) Appl. No.: 16/475,161

(22) PCT Filed: Nov. 24, 2017
(86) PCT No.: PCT/KR2017/013456

§ 371 Date: Jul. 1, 2019

(30) Foreign Application Priority Data
Jan. 5, 2017 (KR) 10-2017-0001651

(51) Int. Cl. H02G 1/02; H02G 7/05; H02G 1/00

(52) U.S. Cl. CPC H02G 1/02; H02G 1/005; H02G 7/053

(57) ABSTRACT

Provided is a method for performing uninterruptible power distribution work within a working section in a de-energized line state by separating wires within a pole-to-pole span by means of an insulated live wire grip and a bypass jumper cable, wherein: uninterruptible power distribution work can be forcibly performed directly on a live wire between poles located at the beginning and end of a working section without installing a bypass cable at the work site, and the work process employs a direct power transmission method in which power distribution work is performed by bypassing new and old wires, whereby, even when transformers are located at several points within a working section, uninterruptible power distribution work can be performed via one uninterruptible transformer apparatus by using, as the interruptible power distribution method.

### TECHNICAL FIELD

The present invention relates to an uninterruptible power distribution method in a distribution line, and more particularly to an uninterruptible power distribution method for performing in-section work in a dead-line state by separating an electric wire within a pole-to-pole span using an insulated live-line wire grip and a bypass jumper wire that is capable of being performed in a wide variety of conditions at a work site when uninterruptible work is performed while preventing safety-related accidents due to immoderate work and preventing the congestion of traffic at the work site due to excessive input of equipment and manpower, thereby improving work efficiency.

### BACKGROUND ART

With the rapid increase in the demand for electric power, electric power equipment corresponding thereto has been continuously enlarged. As the level of electric power consumers' demand for high-quality electrical service increases, instantaneous electric power failure has become a target of public grievance. As a result, collective activities and legal proceedings by electric power consumers, such as requests for compensation, have increased. For these reasons, electric power distribution work is performed in the state in which the supply of electric power is not interrupted in order to supply high-quality electric power. That is, an uninterruptible power distribution method is used.

A temporary electric power transmission method using a bypass cable, which is one of the conventional uninterruptible power distribution methods in an ultra-high-voltage distribution line, has been used. In this method, three ultra-high-voltage phases are temporarily connected every 50 m via an intermediate connection member using a switch for work and a three-phase bypass cable. In the case in which a transformer is present within a work section, divergence is realized using a divergence connection member at each point at which the transformer is installed in order to supply electric power to each uninterruptible transformer apparatus. In the case in which a divergence line is present, electric power is supplied to the divergence line using a divergence connection member. As a result, work is performed once within a work section having a length of 200 to 300 m.

In this case, however, there are many temporary connection points that are unstable, for example, due to voltage drop. In addition, the three-phase bypass cable is temporarily laid on the ground and is then removed when work is completed. As a result, excessive time is required to perform incidental work. In the case in which an uninterruptible power distribution method using an electric wire relocation tool and additional direct live-line work are performed, three live-line electric wires and three dead-line electric wires are provided in a mixed state when the electric wires are stretched and tensioned at opposite sides of a work section, whereby safety-related accidents may occur due to mixed contact between electric wires and confusion between the electric wires. For these reasons, live-line distribution workers avoid direct live-line distribution work. As a result, the use of a direct live-line distribution method, i.e. an uninterruptible power distribution method using an electric lower relocation tool, has stopped, and no new method or substitute therefor has been proposed. In the case of a heavy-load line, however, load switching is not possible. Consequently, uninterruptible work is not possible using a conventional bypass cable work method, whereby previously ordered work may be canceled, the likelihood of power failures during work may be increased due to work in the state in which electric power is not supplied, inconvenience in people's lives may be incurred, and public discontent may be caused.

### PRIOR ART DOCUMENT

### Patent Document

(PATENT DOCUMENT 1) Korean Patent Registration Publication No. 10-1122499

### DISCLOSURE

### Technical Problem

The present invention has been made in view of the above problems with the conventional art, and it is an object of the present invention to provide an uninterruptible power distribution method for performing in-section work in a dead-line state by separating an electric wire within a pole-to-pole span using an insulated live-line wire grip and a bypass jumper wire that is capable of remarkably reducing safety-related accidents that occur as the result of immoderate direct live-line uninterruptible work performed at a work-section start electric pole and a work-section end electric pole without laying a bypass cable at a work site, thereby achieving efficient uninterruptible power distribution while improving economy and site utilization efficiency.

It is another object of the present invention to provide an uninterruptible power distribution method for performing in-section work in a dead-line state by separating an electric wire within a pole-to-pole span using an insulated live-line wire grip and a bypass jumper wire that is capable of performing a work process using a direct electric power transmission method of bypassing newly established electric wires and new and old electric wires to be removed, thereby simplifying work, wherein, in the case of a heavy-load line, an uninterruptible type direct electric power transmission method, in which load switching is not performed, is performed, and, even in the case in which a plurality of transformers is present within the work section, uninterruptible work is possible using a single uninterruptible transformer apparatus, whereby the method is easily applicable in the central area of a town, which is crowded, i.e. in a city, traffic congestion and danger to passing pedestrians are prevented, and work convenience, safety, and economy are improved.

### Technical Solution

In accordance with the present invention, the above and other objects can be accomplished by the provision of an uninterruptible power distribution method, wherein, in the case in which electric pole relocation work, electric pole replacement work, and electric pole route change work are performed in an uninterruptible state, the uninterruptible power distribution method includes:

a process of performing electric-pole establishment work, electric-pole assembly work, and electric wiring work within a work section in a dead-line state in order to perform uninterruptible preparation work;

a process of installing electric wire clips of insulated live-line wire grips for holding tension of electric wires inside a work section defined by a work-section start electric pole and a work-section end electric pole at points at which a safe dead-line work section of electric wires to be removed is secured;

a process of connecting one end of a bypass jumper means to an electric wire to be removed outside each of the electric wire clips of the insulated live-line wire grips, installed within the work section defined by the work-section start electric pole and the work-section end electric pole, and connecting the other end of the bypass jumper means to an old electric wire located outside each of the work-section start electric pole and the work-section end electric pole deviating from the work section, thereby completing bypass connection;

a process of sequentially separating jumper wires of the work-section start electric pole and the work-section end electric pole and separating an electric wire to be removed within the span of the electric poles from the point at which each of the electric wire clips of the insulated live-line wire grips is held;

a process of removing an electric wire to be removed extending from the point of separation within the span of the work-section start electric pole and the work-section end electric pole to a suspension insulator of each electric pole in order to secure a safe dead-line work space, and stretching, tensioning, and fixing newly established electric wires;

a process of sequentially connecting jumper wires of the newly established electric wires, wired to the work-section start electric pole and the work-section end electric pole, to the old electric wires and separating the installed bypass jumper means; and

a process of removing the electric wires to be removed, the tension of each of which is held by a corresponding one of the electric wire clips of the insulated live-line wire grips, and an electric pole corresponding thereto,

wherein, in the case in which a branch-line electric pole is present within the work section, the uninterruptible power distribution method includes:

a process of performing electric-pole establishment work, electric-pole assembly work, and electric wiring work within the work section in the dead-line state in order to perform uninterruptible preparation work;

a process of installing electric wire clips of insulated live-line wire grips for holding tension of electric wires inside a work section defined by a work-section start electric pole and a work-section end electric pole, within which the branch-line electric pole is present, at points at which a safe dead-line work section of electric wires to be removed is secured;

a process of connecting one end of a bypass jumper means to an electric wire to be removed outside each of the electric wire clips of the insulated live-line wire grips, installed at the work-section start electric pole and the work-section end electric pole, and connecting the other end of the bypass jumper means to an old electric wire located outside each of the work-section start electric pole and the work-section end electric pole deviating from the work section, thereby completing bypass connection;

a process of sequentially separating jumper wires of the work-section start electric pole and the work-section end electric pole and separating an electric wire to be removed within the span of the electric poles from the point at which each of the electric wire clips of the insulated live-line wire grips is held;

a process of removing an electric wire to be removed extending from the point of separation within the span of the work-section start electric pole and the work-section end electric pole to a suspension insulator of each electric pole in order to secure a safe dead-line work space, and stretching, tensioning, and fixing newly established electric wires;

a process of installing electric wire clips of insulated live-line wire grips for holding tension of electric wires inside a work section defined by the branch-line electric pole at points at which a safe dead-line work section of electric wires to be removed is secured;

a process of connecting one end of a bypass jumper means to an electric wire to be removed outside each of the electric wire clips of the insulated live-line wire grips, installed at the branch-line electric pole, and connecting the other end of the bypass jumper means to an old electric wire located outside the branch-line electric pole deviating from the work section, thereby completing bypass connection;

a process of sequentially separating jumper wires of the branch-line electric pole and separating an electric wire to be removed within a span of the branch-line electric pole from the point at which each of the electric wire clips of the insulated live-line wire grips is held;

a process of removing an electric wire to be removed extending from the point of separation within the span of the branch-line electric pole to a suspension insulator of the branch-line electric pole in order to secure a safe dead-line work space, and stretching, tensioning, and fixing newly established electric wires;

a process of sequentially connecting jumper wires of the newly established electric wires, wired to the work-section start electric pole, the work-section end electric pole, and the branch-line electric pole, to the old electric wires and separating the installed bypass jumper means; and

a process of removing the electric wires to be removed, the tension of each of which is held by a corresponding one of the electric wire clips of the insulated live-line wire grips, and an electric pole corresponding thereto, and

wherein, in the case in which an electric pole having a pole-mounted transformer is present within the work section, the uninterruptible power distribution method includes:

a process of performing electric-pole establishment work, electric-pole assembly work, and electric wiring work within the work section in the dead-line state in order to perform uninterruptible preparation work;

a process of installing electric wire clips of insulated live-line wire grips for holding tension of electric wires inside a work section defined by a work-section start electric pole and a work-section end electric pole, within which the branch-line electric pole is present, at points at which a safe dead-line work section of electric wires to be removed is secured;

a process of connecting one end of a bypass jumper means to an electric wire to be removed outside each of the electric wire clips of the insulated live-line wire grips, installed within the work section defined by the work-section start electric pole and the work-section end electric pole, and connecting the other end of the bypass jumper means to an old electric wire located outside each of the work-section start electric pole and the work-section end electric pole deviating from the work section, thereby completing bypass connection;

a process of sequentially separating jumper wires of the work-section start electric pole and the work-section end electric pole and separating an electric wire to be removed within the span of the electric poles from the point at which each of the electric wire clips of the insulated live-line wire grips is held;

a process of removing an electric wire to be removed extending from the point of separation within the span of the work-section start electric pole and the work-section end electric pole to a suspension insulator of each electric pole in order to secure a safe dead-line work space, and stretching, tensioning, and fixing newly established electric wires;

a process of sequentially connecting jumper wires of the newly established electric wires, wired to the work-section start electric pole and the work-section end electric pole, to the old electric wires;

a process of installing an uninterruptible transformer apparatus at the electric pole having the pole-mounted transformer within the work section, connecting and a secondary low-voltage cable of the uninterruptible transformer apparatus to a secondary low-voltage wire of an installed pole-mounted transformer, thereby completing bypass connection, separating a secondary drop wire of the pole-mounted transformer, opening a COS of the pole-mounted transformer, and removing the pole-mounted transformer;

a process of installing the removed pole-mounted transformer at a newly established electric pole or installing a new pole-mounted transformer at the newly established electric pole, closing a COS of a newly established pole-mounted transformer, connecting a secondary drop wire of the pole-mounted transformer, powering off the uninterruptible transformer apparatus, and separating a low-voltage cable of the uninterruptible transformer apparatus, thereby completing the replacement and relocation of the pole-mounted transformer within the work section; and

a process of separating the bypass jumper means, installed at the work-section start electric pole and the work-section end electric pole, and removing the electric wires to be removed, the tension of each of which is held by a corresponding one of the electric wire clips of the insulated live-line wire grips within the section between the work-section start electric pole and the work-section end electric pole, an electric pole corresponding thereto, and the uninterruptible transformer apparatus.

### Advantageous Effects

As is apparent from the above description, an uninterruptible power distribution method for performing in-section work in a dead-line state by separating an electric wire within a pole-to-pole span using an insulated live-line wire grip and a bypass jumper wire according to the present invention has the following effects. In the case in which uninterruptible work is performed using a conventional bypass cable work method in the state in which dead-line preparation work is completed, except for uninterruptible work at a work-section start electric pole and a work-section end electric pole at a work site, a bypass cable is laid in order to perform uninterruptible work for safety even in a section in which the preparation of work has already been completed, which reduces work efficiency and site utilization efficiency. According to the present invention, however, it is possible to remarkably reduce safety-related accidents that occur as the result of immoderate direct live-line uninterruptible work performed at a work-section start electric pole and a work-section end electric pole without laying a bypass cable at a work site, thereby improving economy and site utilization efficiency.

In addition, an intermediate connection in the middle of the bypass cable is not necessary, and no divergence connection member of the bypass cable is used. Furthermore, according to the present invention, it is possible to perform a work process using a direct electric power transmission method of bypassing newly established electric wires and new and old electric wires to be removed, thereby simplifying work, wherein, in the case of a heavy-load line, an uninterruptible type direct electric power transmission method, in which load switching is not performed, is performed, and, even in the case in which a plurality of transformers is present within the work section, uninterruptible work is possible using a single uninterruptible transformer apparatus, whereby the method is easily applicable in the central area of a town, which is crowded, i.e. in a city, traffic congestion and danger to passing pedestrians are prevented, and work convenience, safety, and economy are improved.

### DESCRIPTION OF DRAWINGS

FIG. 1 is a schematic view showing a first embodiment of an uninterruptible power distribution method for performing in-section work in a dead-line state by separating an electric wire within a pole-to-pole span using an insulated live-line wire grip and a bypass jumper wire according to the present invention;

FIG. 2 is a schematic view showing the first embodiment of the uninterruptible power distribution method for performing the in-section work in the dead-line state by separating the electric wire within the pole-to-pole span using the insulated live-line wire grip and the bypass jumper wire according to the present invention;

FIG. 3 is a schematic view showing the first embodiment of the uninterruptible power distribution method for performing the in-section work in the dead-line state by separating the electric wire within the pole-to-pole span using the insulated live-line wire grip and the bypass jumper wire according to the present invention;

FIG. 4 is a schematic view showing the first embodiment of the uninterruptible power distribution method for performing the in-section work in the dead-line state by separating the electric wire within the pole-to-pole span using the insulated live-line wire grip and the bypass jumper wire according to the present invention;

FIG. 5 is a schematic view showing the first embodiment of the uninterruptible power distribution method for performing the in-section work in the dead-line state by separating the electric wire within the pole-to-pole span using the insulated live-line wire grip and the bypass jumper wire according to the present invention;

FIG. 6 is a schematic view showing the first embodiment of the uninterruptible power distribution method for performing the in-section work in the dead-line state by separating the electric wire within the pole-to-pole span using the insulated live-line wire grip and the bypass jumper wire according to the present invention;

FIG. 7 is a schematic view showing a second embodiment of an uninterruptible power distribution method for performing in-section work in a dead-line state by separating an electric wire within a pole-to-pole span using an insulated live-line wire grip and a bypass jumper wire according to the present invention;

FIG. 8 is a schematic view showing the second embodiment of the uninterruptible power distribution method for performing the in-section work in the dead-line state by separating the electric wire within the pole-to-pole span using the insulated live-line wire grip and the bypass jumper wire according to the present invention;

FIG. 9 is a schematic view showing the second embodiment of the uninterruptible power distribution method for performing the in-section work in the dead-line state by separating the electric wire within the pole-to-pole span using the insulated live-line wire grip and the bypass jumper wire according to the present invention;

FIG. 10 is a schematic view showing the second embodiment of the uninterruptible power distribution method for performing the in-section work in the dead-line state by separating the electric wire within the pole-to-pole span using the insulated live-line wire grip and the bypass jumper wire according to the present invention;

FIG. 11 is a schematic view showing the second embodiment of the uninterruptible power distribution method for performing the in-section work in the dead-line state by separating the electric wire within the pole-to-pole span using the insulated live-line wire grip and the bypass jumper wire according to the present invention;

FIG. 12 is a schematic view showing the second embodiment of the uninterruptible power distribution method for performing the in-section work in the dead-line state by separating the electric wire within the pole-to-pole span using the insulated live-line wire grip and the bypass jumper wire according to the present invention;

FIG. 13 is a schematic view showing a third embodiment of an uninterruptible power distribution method for performing in-section work in a dead-line state by separating an electric wire within a pole-to-pole span using an insulated live-line wire grip and a bypass jumper wire according to the present invention;

FIG. 14 is a schematic view showing the third embodiment of the uninterruptible power distribution method for performing the in-section work in the dead-line state by separating the electric wire within the pole-to-pole span using the insulated live-line wire grip and the bypass jumper wire according to the present invention;

FIG. 15 is a schematic view showing the third embodiment of the uninterruptible power distribution method for performing the in-section work in the dead-line state by separating the electric wire within the pole-to-pole span using the insulated live-line wire grip and the bypass jumper wire according to the present invention;

FIG. 16 is a schematic view showing the third embodiment of the uninterruptible power distribution method for performing the in-section work in the dead-line state by separating the electric wire within the pole-to-pole span using the insulated live-line wire grip and the bypass jumper wire according to the present invention;

FIG. 17 is a schematic view showing the third embodiment of the uninterruptible power distribution method for performing the in-section work in the dead-line state by separating the electric wire within the pole-to-pole span using the insulated live-line wire grip and the bypass jumper wire according to the present invention;

FIG. 18 is a schematic view showing the third embodiment of the uninterruptible power distribution method for performing the in-section work in the dead-line state by separating the electric wire within the pole-to-pole span using the insulated live-line wire grip and the bypass jumper wire according to the present invention;

FIG. 19 is a schematic view showing the third embodiment of the uninterruptible power distribution method for performing the in-section work in the dead-line state by separating the electric wire within the pole-to-pole span using the insulated live-line wire grip and the bypass jumper wire according to the present invention;

FIG. 20 is a schematic view showing the third embodiment of the uninterruptible power distribution method for performing the in-section work in the dead-line state by separating the electric wire within the pole-to-pole span using the insulated live-line wire grip and the bypass jumper wire according to the present invention;

FIG. 21 is a schematic view showing a fourth embodiment of an uninterruptible power distribution method for performing in-section work in a dead-line state by separating an electric wire within a pole-to-pole span using an insulated live-line wire grip and a bypass jumper wire according to the present invention;

FIG. 22 is a schematic view showing the fourth embodiment of the uninterruptible power distribution method for performing the in-section work in the dead-line state by separating the electric wire within the pole-to-pole span using the insulated live-line wire grip and the bypass jumper wire according to the present invention;

FIG. 23 is a schematic view showing the fourth embodiment of the uninterruptible power distribution method for performing the in-section work in the dead-line state by separating the electric wire within the pole-to-pole span using the insulated live-line wire grip and the bypass jumper wire according to the present invention;

FIG. 24 is a schematic view showing the fourth embodiment of the uninterruptible power distribution method for performing the in-section work in the dead-line state by separating the electric wire within the pole-to-pole span using the insulated live-line wire grip and the bypass jumper wire according to the present invention;

FIG. 25 is a schematic view showing the fourth embodiment of the uninterruptible power distribution method for performing the in-section work in the dead-line state by separating the electric wire within the pole-to-pole span using the insulated live-line wire grip and the bypass jumper wire according to the present invention;

FIG. 26 is a schematic view showing the fourth embodiment of the uninterruptible power distribution method for performing the in-section work in the dead-line state by separating the electric wire within the pole-to-pole span using the insulated live-line wire grip and the bypass jumper wire according to the present invention;

FIG. 27 is a schematic view showing the fourth embodiment of the uninterruptible power distribution method for performing the in-section work in the dead-line state by separating the electric wire within the pole-to-pole span using the insulated live-line wire grip and the bypass jumper wire according to the present invention;

FIG. 28 is a schematic view showing the fourth embodiment of the uninterruptible power distribution method for performing the in-section work in the dead-line state by separating the electric wire within the pole-to-pole span using the insulated live-line wire grip and the bypass jumper wire according to the present invention; and

FIG. 29 is a schematic view showing another embodiment of an uninterruptible power distribution method for performing in-section work in a dead-line state by separating an electric wire within a pole-to-pole span using an insulated live-line wire grip and a bypass jumper wire according to the present invention.

### DESCRIPTION OF REFERENCE SYMBOLS

1: Electric wires to be removed 1a: Electric wires to be removed of branch line
2: Old electric wires 2a: Old electric wires of branch line
3: Jumper wires 3a: Jumper wires of branch line
10: Start and end electric poles 10b: Electric pole having pole-mounted transformer
20: Insulated live-line wire grips 30 (30a): Bypass jumper cables
30b: Work switch 30c: Terminal cable for switch
50: Pole-mounted transformer 50a: Pole-mounted transformer of newly established electric pole
51: COS 51a: COS of newly established electric pole
52: Secondary drop wire of transformer 52a: Secondary drop wire of newly established transformer
60: Uninterruptible transformer apparatus
70: Extra-high-voltage cable 70a: Low-voltage cable
80: Secondary low-voltage wire 80a: Secondary low-voltage wire of newly established electric pole
100: Newly established electric pole 100a: Branch-line electric pole
100b: Newly established electric pole having pole-mounted transformer
110: Newly established electric wires 110a: Newly established electric wires of branch line
130: Jumper wires of newly established electric wires 130a: Jumper wires of newly established electric wires of branch line

### BEST MODE

It should be noted that terms or words used in this specification and the claims are not to be interpreted as having ordinary and dictionary-based meanings but as having meanings and concepts coinciding with the technical idea of the present invention based on the principle that the inventors may appropriately define the concepts of the terms in order to explain the invention in the best method.

Consequently, the embodiments described in this specification with reference to the accompanying drawings are merely the most preferred embodiments, and do not cover all technical ideas of the present invention, and therefore it should be understood that there may be various equivalents and modifications capable of substituting for the embodiments at the time of filing of the present application.

Hereinafter, preferred embodiments of the present invention will be described in detail with reference to the accompanying drawings.

An uninterruptible power distribution method for performing in-section work in a dead-line state by separating an electric wire within a pole-to-pole span using an insulated live-line wire grip and a bypass jumper wire according to the present invention is capable of being performed in an uninterruptible state according to various embodiments in the case in which electric pole relocation work, electric pole replacement work, and electric pole route change work are performed in an uninterruptible state, wherein the uninterruptible power distribution method is capable of being performed according to various embodiments described hereinafter.

### Embodiment 1

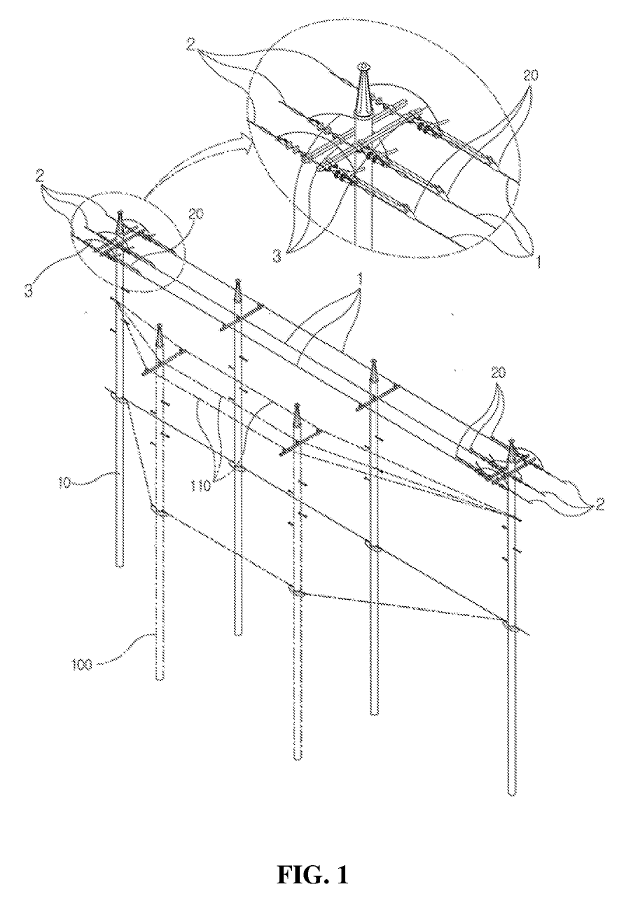

The case in which electric pole relocation work, electric pole replacement work, and electric pole route change work are performed, as shown in FIG. 1

When electric pole relocation work, electric pole replacement work, and electric pole route change work are performed in an uninterruptible state, electric-pole establishment work, electric-pole assembly work, and electric wiring work are performed within a work section in a dead-line state, except for uninterruptible work at a work-section start electric pole and a work-section end electric pole, in order to perform uninterruptible preparation work, whereby preparation to perform uninterruptible work is achieved.

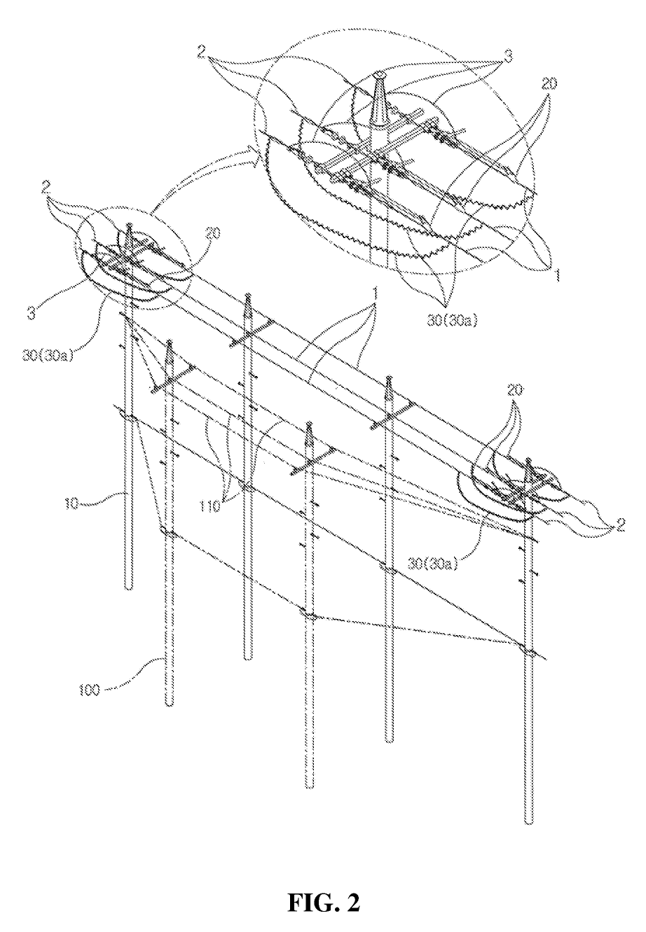

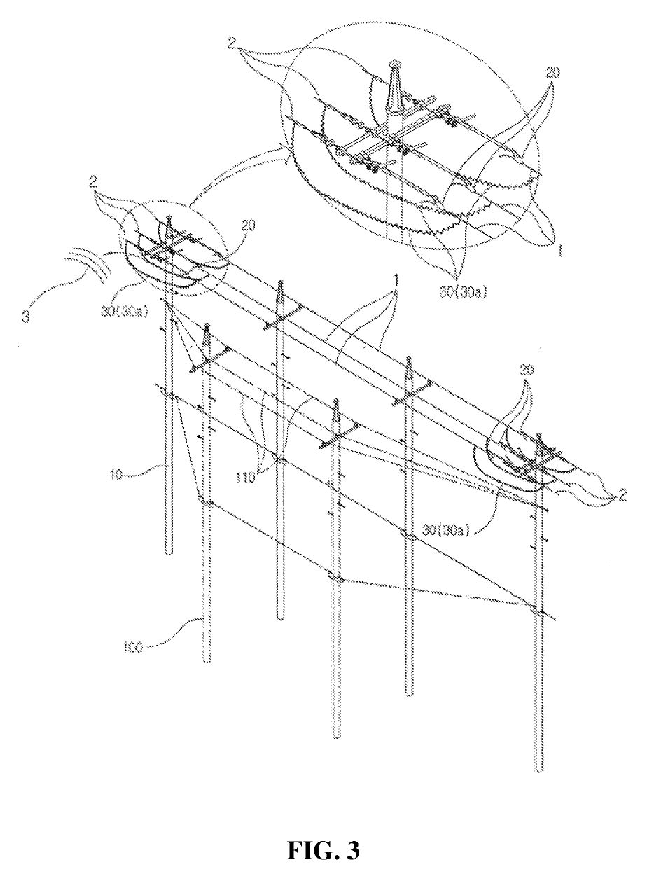

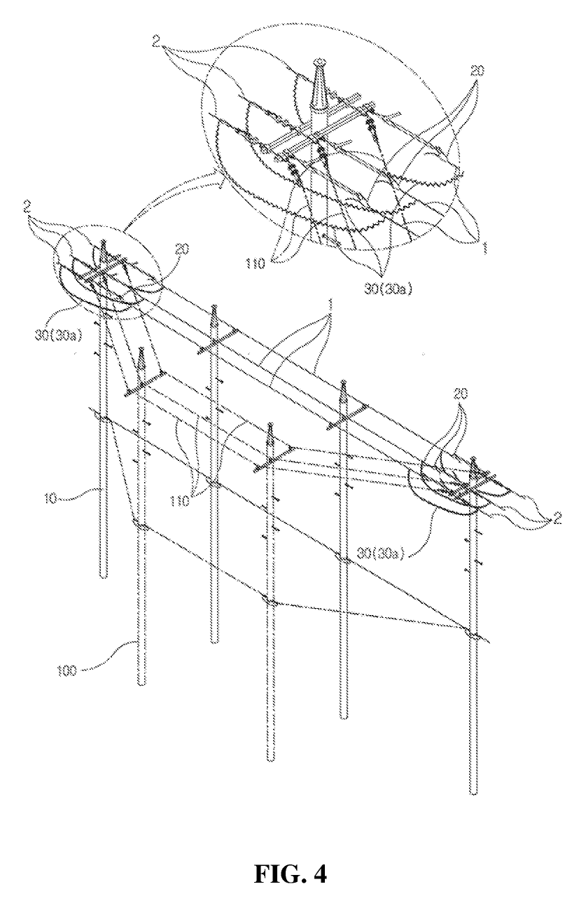

At this time, when the uninterruptible work is performed, as shown in FIG. 2, electric wire clips of insulated live-line wire grips 20 for holding the tension of electric wires are installed inside a work section defined by a work-section start electric pole 10 and a work-section end electric pole 10 at points at which a safe dead-line work section of electric wires to be removed is secured. After the installation is completed, one end of a bypass jumper means 30 is connected to an electric wire outside each of the electric wire clips of the insulated live-line wire grips 20, and the other end of the bypass jumper means 30 is connected to an electric wire located outside each of the work-section start electric pole 10 and the work-section end electric pole 10 deviating from the work section, whereby bypass connection is completed. As shown in FIG. 3, jumper wires 3 of the work-section start electric pole 10 and the work-section end electric pole 10 are sequentially separated, and then, as shown in FIG. 4, an electric wire within the pole-to-pole span is separated from the point at which each of the electric wire clips of the insulated live-line wire grips 20 is held, whereby a safe dead-line work section is formed. Subsequently, the electric wire extending from the point of separation to a suspension insulator of each electric pole is removed in a dead-line state in order to secure a safe dead-line work section in which newly established electric wires 110 are stretched and tensioned.

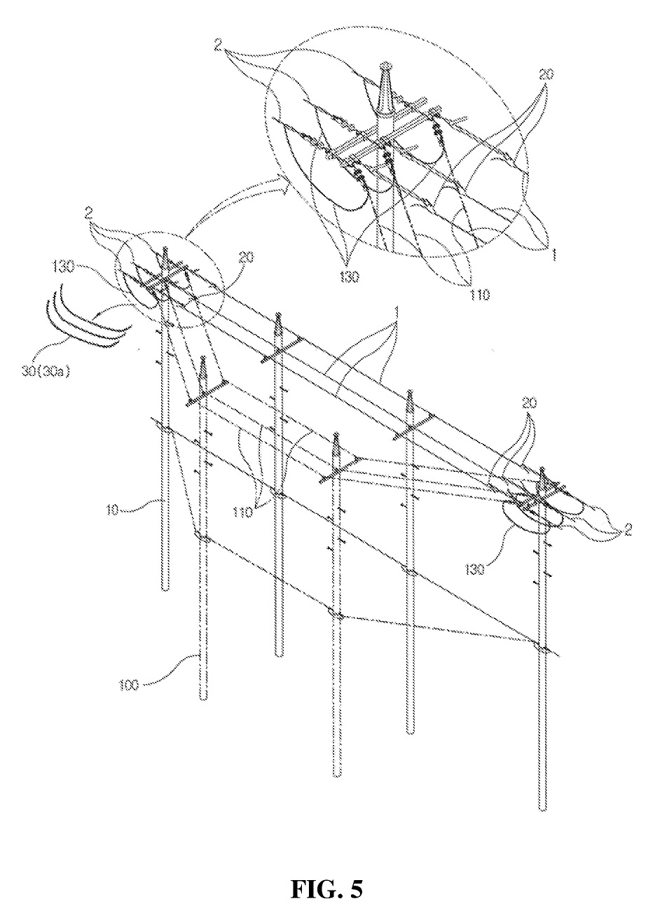

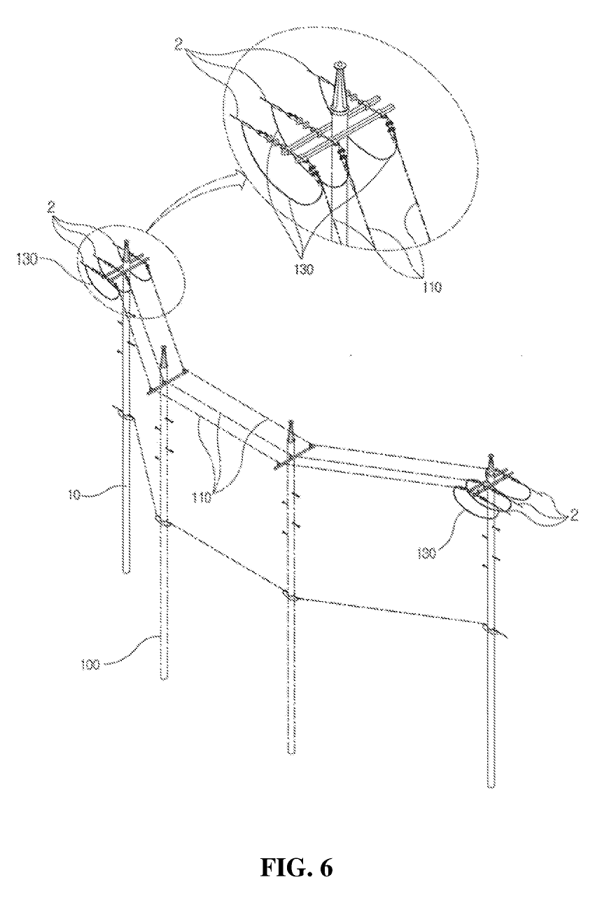

As shown in FIG. 5, electric pole establishment is completed at each of the work-section start electric pole 10 and the work-section end electric pole 10 in a dead-line state, the newly established electric wires 110 are stretched, tensioned, and fixed, and jumper wires 130 of the newly established electric wires 110, which have been stretched and tensioned at each of the work-section start electric pole 10 and the work-section end electric pole 10, are sequentially connected to old electric wires 2 in a bypass fashion. Subsequently, as shown in FIG. 6, bypass jumper means 30 installed at an electric pole between the work-section start electric pole 10 and the work-section end electric pole 10 are separated, and electric wires 1 to be removed, the tension of each of which is held by a corresponding one of the electric wire clips of the insulated live-line wire grips, and an electric pole corresponding thereto are removed in a dead-line state, whereby it is possible to perform electric pole relocation work, electric pole replacement work, and electric pole route change work in an uninterruptible state.

### Embodiment 2

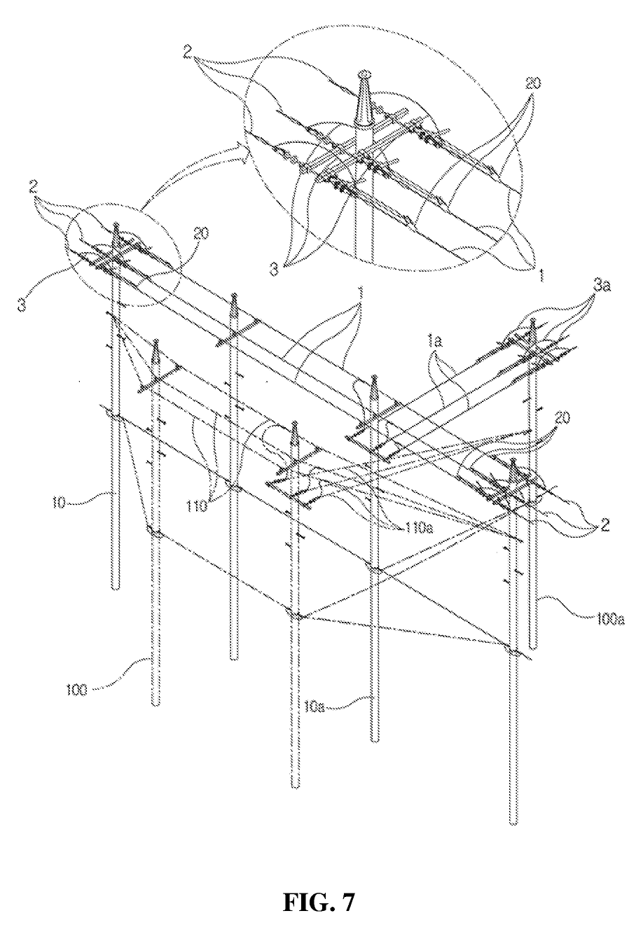

The case in which a branch-line electric pole 100a is present within a work section, as shown in FIG. 7

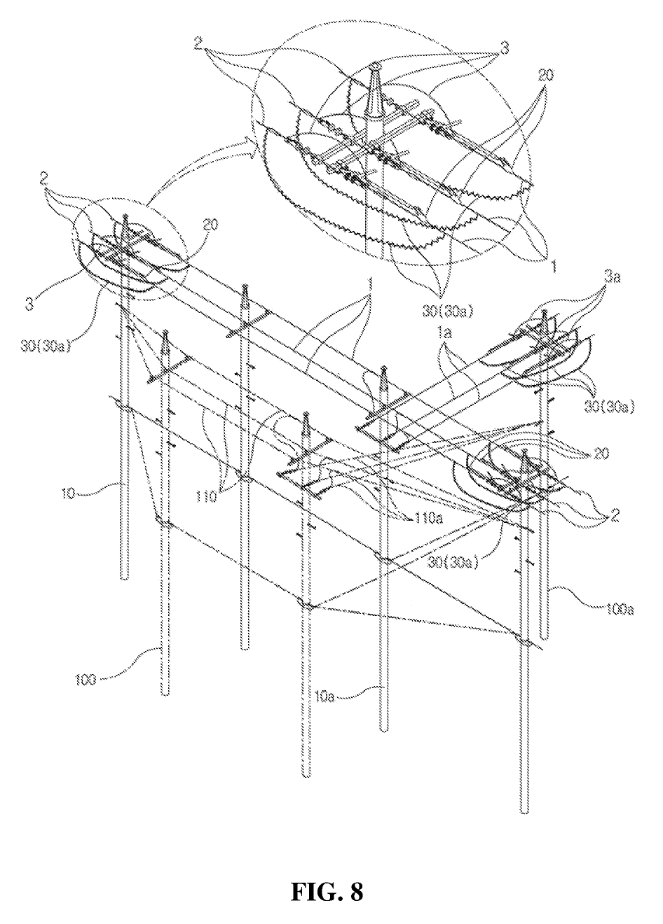

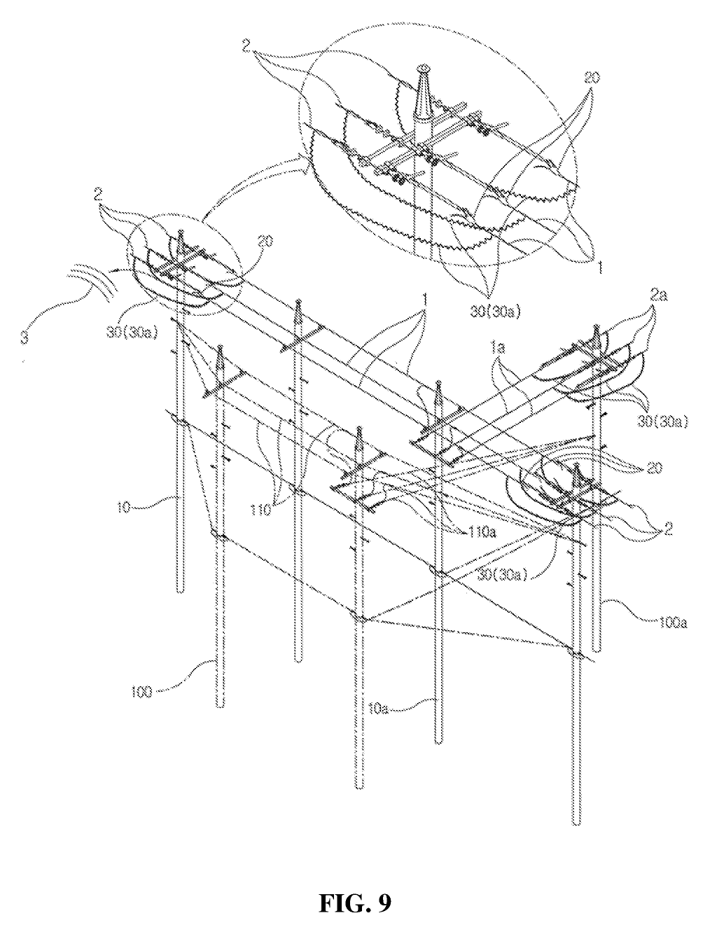

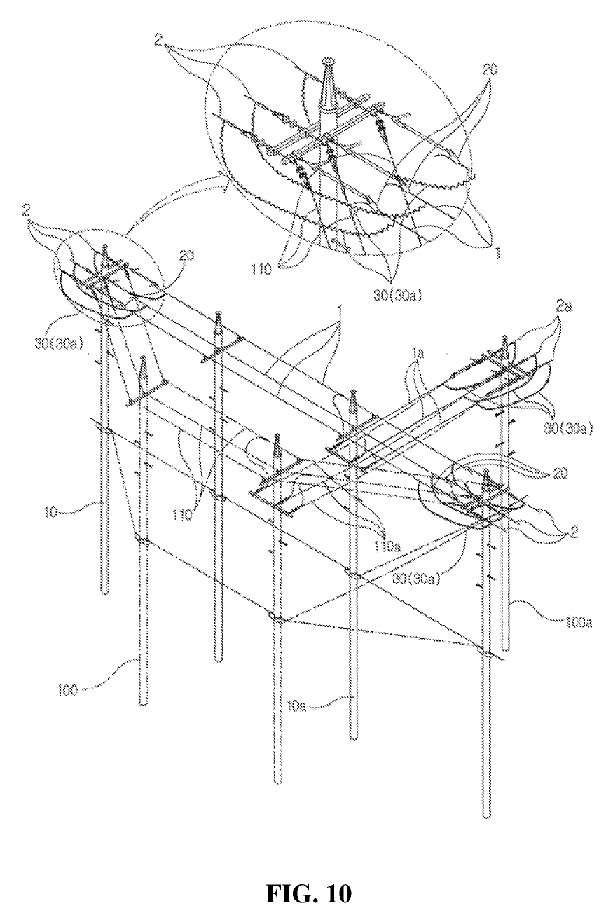

Electric-pole establishment work, electric-pole assembly work, and electric wiring work are performed within a work section in a dead-line state in order to perform uninterruptible preparation work, and, as shown in FIG. 7, electric wire clips of insulated live-line wire grips 20 for holding the tension of electric wires are installed inside a work section defined by a work-section start electric pole 10 and a work-section end electric pole 10 at points at which a safe dead-line work section of electric wires to be removed is secured. After the installation is completed, as shown in FIG. 8, one end of a bypass jumper means 30 is connected to an electric wire outside each of the electric wire clips of the insulated live-line wire grips 20 within the work section span, and the other end of the bypass jumper means 30 is connected to an electric wire located outside each of the work-section start electric pole 10 and the work-section end electric pole 10 deviating from the work section, whereby bypass connection is completed. As shown in FIG. 9, jumper wires 3 of the work-section start electric pole 10 and the work-section end electric pole 10 are separated, and then, as shown in FIG. 10, an electric wire within the pole-to-pole span is separated from the point at which each of the electric wire clips of the insulated live-line wire grips 20 is held, whereby a safe dead-line work section is formed. Subsequently, the electric wire extending from the point of separation to a suspension insulator of each electric pole is removed in a dead-line state in order to remove an obstacle and to secure a safe dead-line work section in which newly established electric wires 110 are stretched and tensioned at each of the work-section start electric pole 10 and the work-section end electric pole 10.

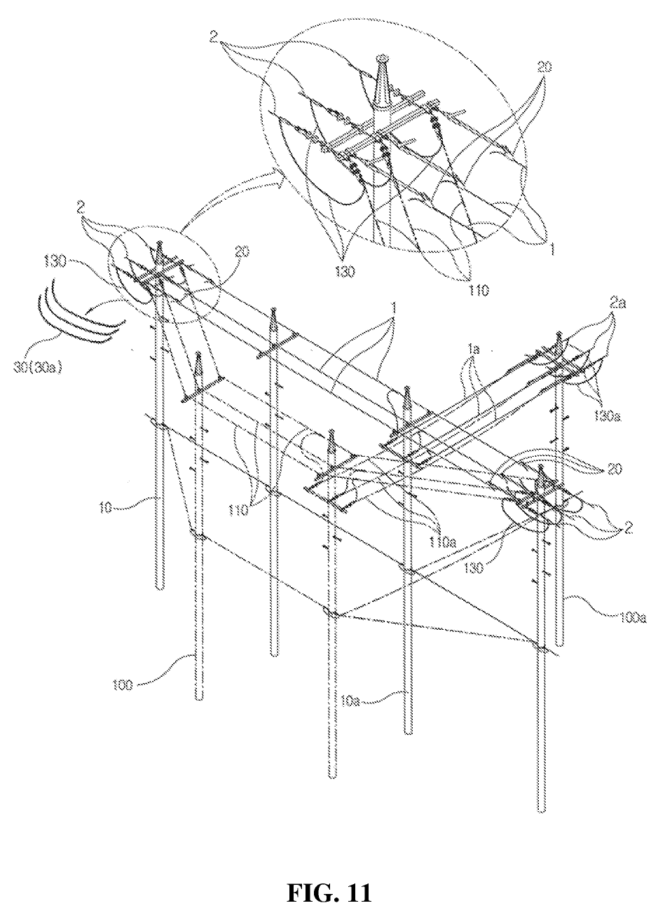

An electric pole is established within the work section, and newly established electric wires 110 are stretched, tensioned, and fixed in a dead-line state at each of the work-section start electric pole 10 and the work-section end electric pole 10, and then, as shown in FIG. 11, jumper wires 130 of the newly established electric wires 110, which have been stretched and tensioned at each of the work-section start electric pole 10 and the work-section end electric pole 10 after the establishment of the electric pole within the work section, are sequentially connected to old electric wires 2 in a bypass fashion.

As shown in FIG. 7, electric wire clips of insulated live-line wire grips 20 for holding the tension of electric wires are installed inside a work section defined by a branch-line electric pole 100a within the work section at points at which a safe dead-line work section of electric wires 1a to be removed is secured. After the installation is completed, as shown in FIG. 8, one end of a bypass jumper means 30 is connected to an electric wire outside each of the electric wire clips of the insulated live-line wire grips 20 within the work section span, and the other end of the bypass jumper means 30 is connected to an electric wire located outside the branch-line electric pole 100a deviating from the work section, whereby bypass connection is completed. As shown in FIG. 9, jumper wires 3a of the branch-line electric pole 100a are separated, and then, as shown in FIG. 10, an electric wire within the pole-to-pole span is separated from the point at which each of the electric wire clips of the insulated live-line wire grips 20 is held, whereby a safe dead-line work section is formed. Subsequently, the electric wire extending from the point of separation to a suspension insulator of each electric pole is removed in a dead-line state in order to secure a safe dead-line work section in which newly established electric wires 110a are stretched and tensioned at the branch-line electric pole 100a.

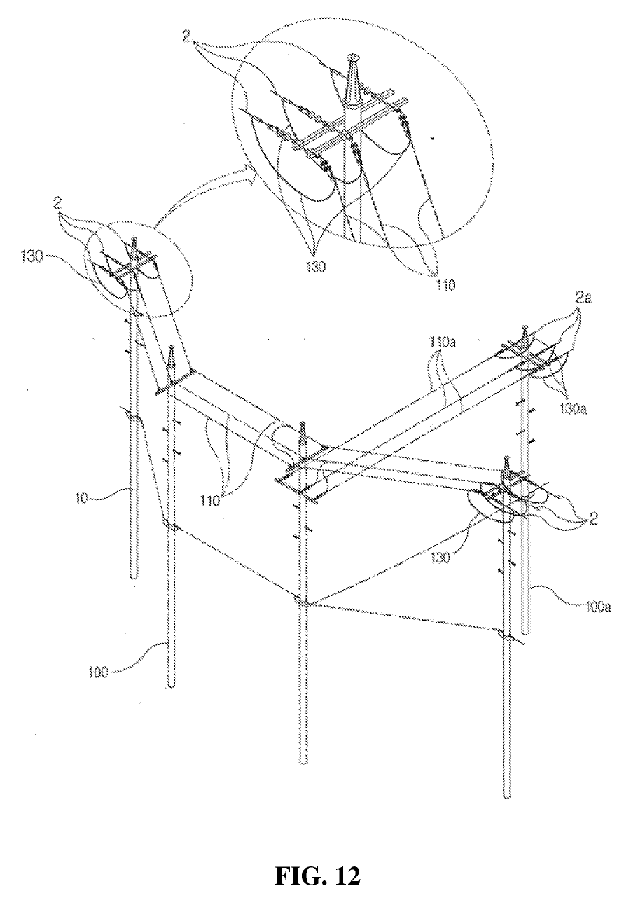

The newly established electric wires 110a are stretched, tensioned, fixed, and connected in a dead-line state at the branch-line electric pole 100a, and then, as shown in FIG. 11, and jumper wires 130a of the newly established electric wires 110a, which have been stretched and tensioned at the branch-line electric pole 100a in the work section, are sequentially connected to old electric wires 2a of the branch line in a bypass fashion. Subsequently, as shown in FIG. 12, bypass jumper means 30 installed at an electric pole between the work-section start electric pole 10 and the work-section end electric pole 10 and the branch-line electric pole 100a are sequentially separated, and electric wires 1 and la to be removed, the tension of each of which is held by a corresponding one of the electric wire clips of the insulated live-line wire grips, and an electric pole corresponding thereto are removed in a dead-line state, whereby it is possible to perform electric pole relocation work, electric pole replacement work, and electric pole route change work in an uninterruptible state in the case in which the branch-line electric pole 100a is present within the work section.

### Embodiment 3

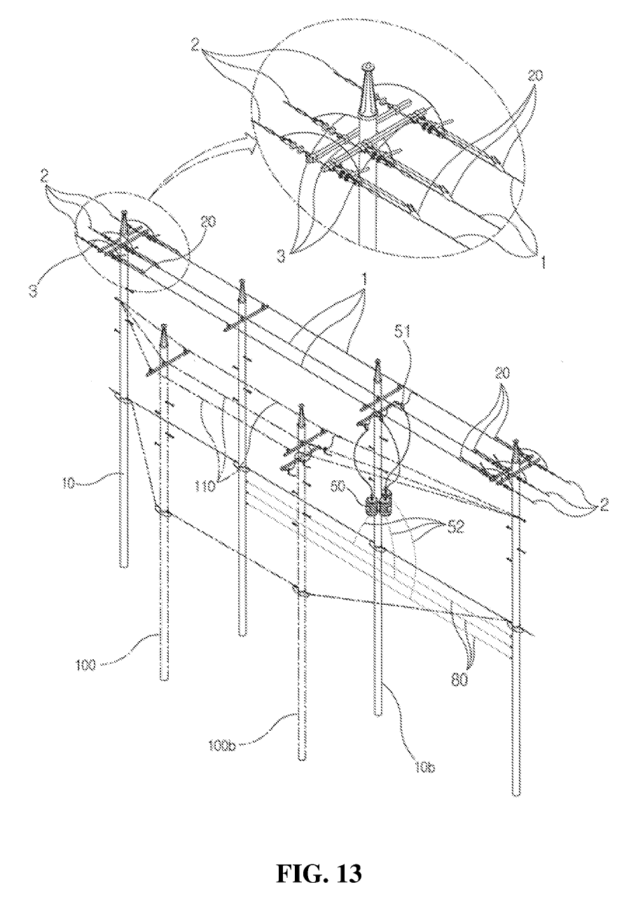

The case in which an electric pole 10b having a pole-mounted transformer is present within a work section, as shown in FIG. 13

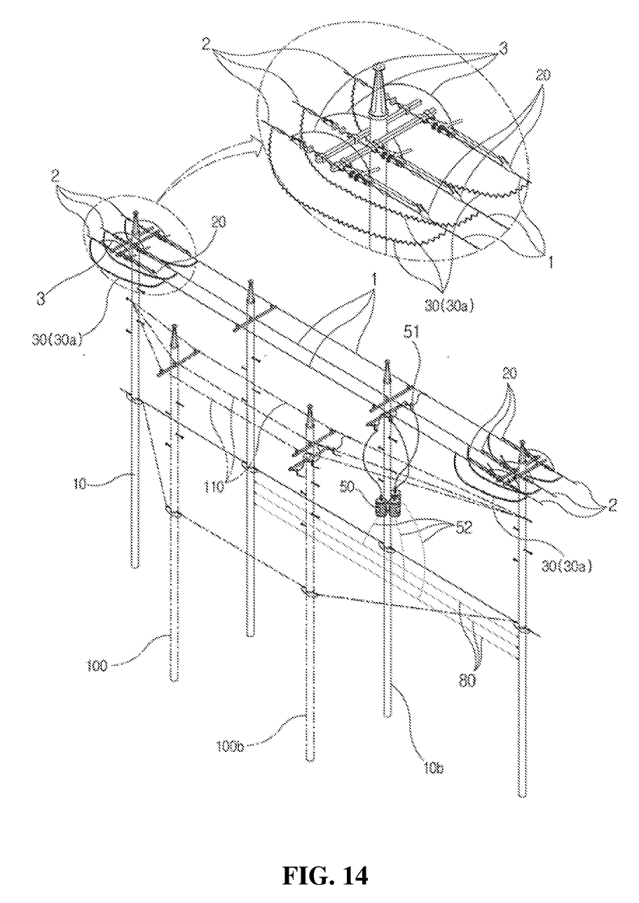

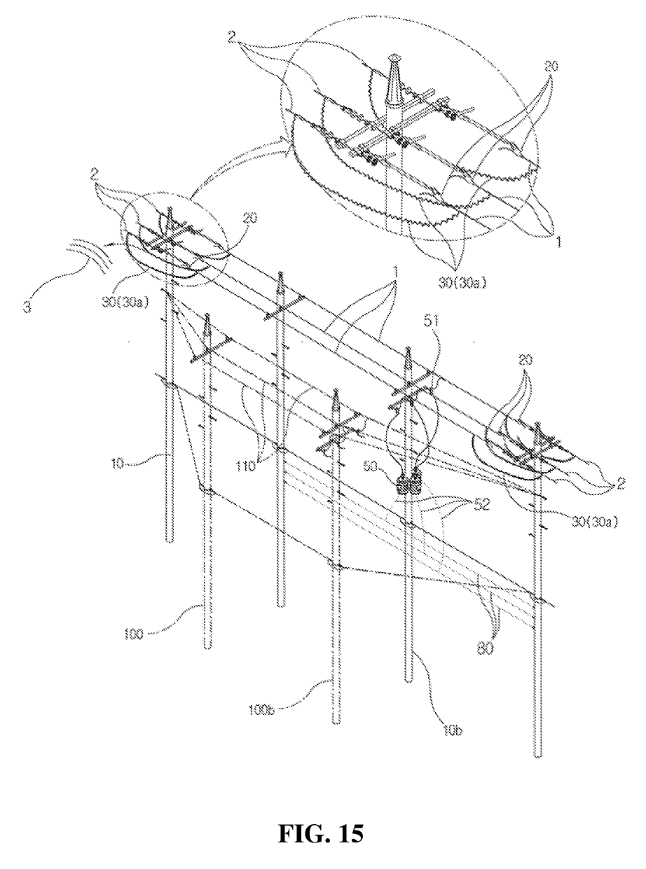

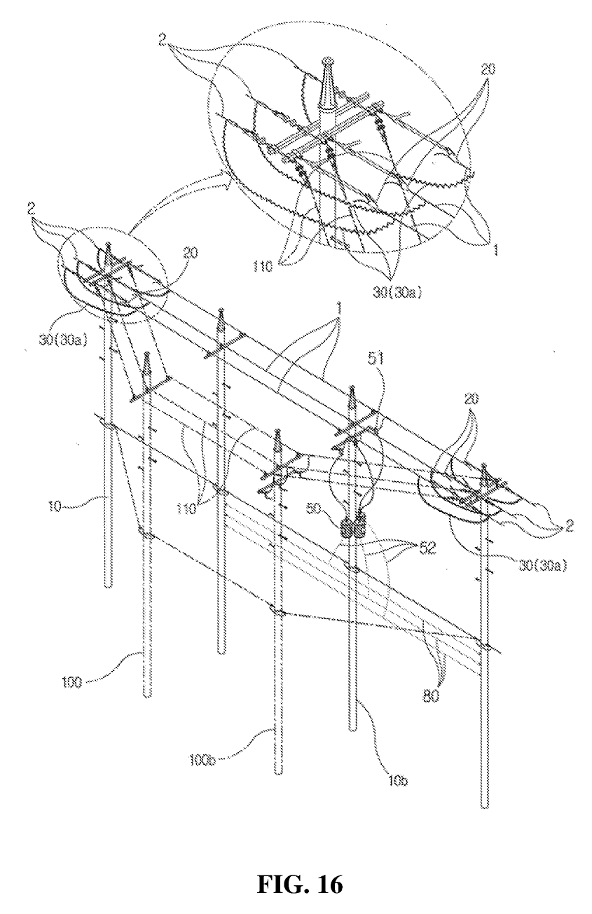

Electric-pole establishment work, electric-pole assembly work, and electric wiring work are performed within a work section in a dead-line state in order to perform uninterruptible preparation work, and, as shown in FIG. 13, electric wire clips of insulated live-line wire grips 20 for holding the tension of electric wires are installed inside a work section defined by a work-section start electric pole 10 and a work-section end electric pole 10 at points at which a safe dead-line work section of electric wires to be removed is secured. After the installation of the insulated live-line wire grips 20 is completed, as shown in FIG. 14, one end of a bypass jumper means 30 is connected to an electric wire outside each of the electric wire clips of the insulated live-line wire grips 20 within the work section span, and the other end of the bypass jumper means 30 is connected to an electric wire located outside each of the work-section start electric pole 10 and the work-section end electric pole 10 deviating from the work section, whereby bypass connection is completed. As shown in FIG. 15, jumper wires 3 of the work-section start electric pole 10 and the work-section end electric pole 10 are separated, and then, as shown in FIG. 16, an electric wire within the pole-to-pole span is separated from the point at which each of the electric wire clips of the insulated live-line wire grips 20 is held, whereby a safe dead-line work section is formed. Subsequently, the electric wire extending from the point of separation to a suspension insulator of each electric pole is removed in a dead-line state in order to secure a safe dead-line work section in which an electric pole is established and newly established electric wires 110 are stretched and tensioned at each of the work-section start electric pole 10 and the work-section end electric pole 10 in a dead-line state.

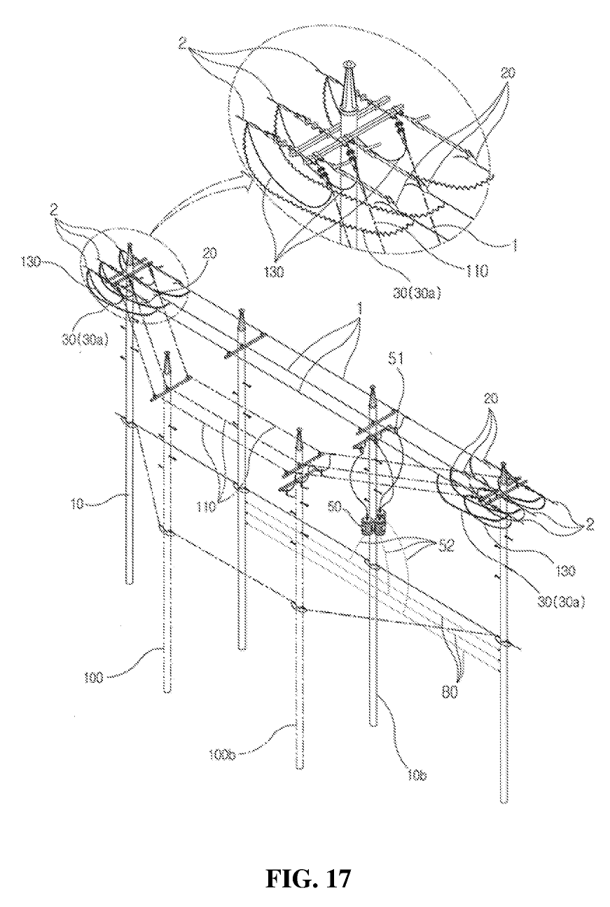

As shown in FIG. 17, an electric pole is established within the work section, and newly established electric wires 110 are stretched, tensioned, and fixed in a dead-line state at each of the work-section start electric pole 10 and the work-section end electric pole 10, and then, as shown in FIG. 17, jumper wires 130 of the newly established electric wires 110, which have been stretched and tensioned at each of the work-section start electric pole 10 and the work-section end electric pole 10 after the establishment of the electric pole within the work section, are sequentially connected to old electric wires 2 in a bypass fashion.

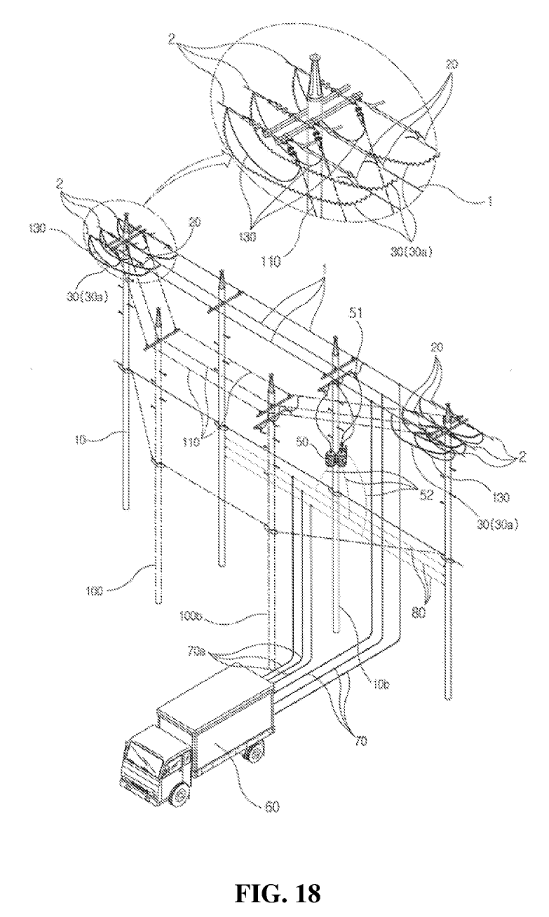

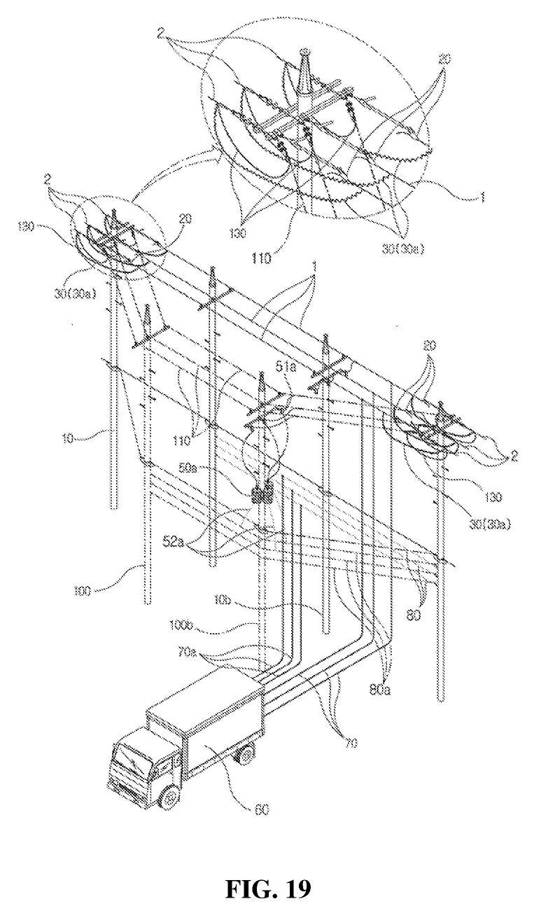

As shown in FIG. 18, an uninterruptible transformer apparatus 60 is installed at an electric pole 10b having a pole-mounted transformer within the work section, and a secondary low-voltage cable 70a of the uninterruptible transformer apparatus is connected to a secondary low-voltage wire 80 of an installed pole-mounted transformer 50, whereby bypass connection is completed. Subsequently, as shown in FIG. 19, a secondary drop wire 52 of the pole-mounted transformer 50 is separated, a COS 51 of the pole-mounted transformer is opened, the pole-mounted transformer 50 is removed and reused so as to be installed at a newly established electric pole 100b or a new pole-mounted transformer is installed at the newly established electric pole 100b, a COS 51a of the newly established pole-mounted transformer 50a is closed, a secondary drop wire 52a of the transformer is connected, the uninterruptible transformer apparatus 60 is powered off, and a low-voltage cable 70a of the uninterruptible transformer apparatus 60 is separated, whereby the uninterruptible establishment and relocation of the transformer within the work section is completed.

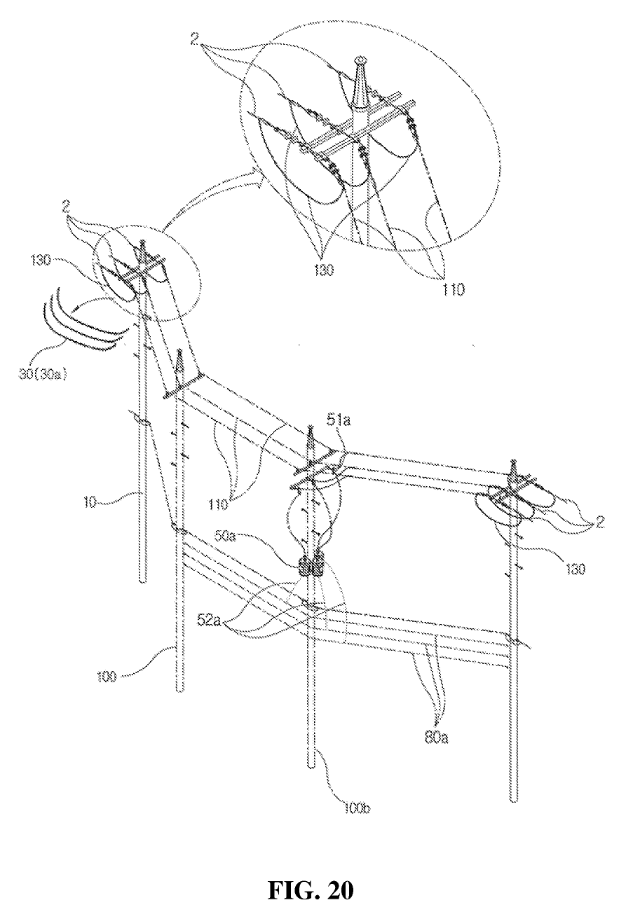

In the case in which a plurality of electric poles each having a pole-mounted transformer 50 is present within the work section, the process of relocating the pole-mounted transformer 50 is repeatedly performed a number of times equal to the number of electric poles each having a pole-mounted transformer. After the replacement and relocation of the pole-mounted transformers within the work section is completed, as shown in FIG. 20, bypass jumper means 30 installed at an electric pole between the work-section start electric pole 10 and the work-section end electric pole 10 and the branch-line electric pole 100a are separated, and electric wires 1 to be removed, the tension of each of which is held by a corresponding one of the electric wire clips of the insulated live-line wire grips, an electric pole corresponding thereto, and the uninterruptible transformer apparatus 60 are removed in a dead-line state, whereby it is possible to perform electric pole relocation work, electric pole replacement work, and electric pole route change work in an uninterruptible state in the case in which the electric pole having the transformer mounted thereto is present within the work section.

### Embodiment 4

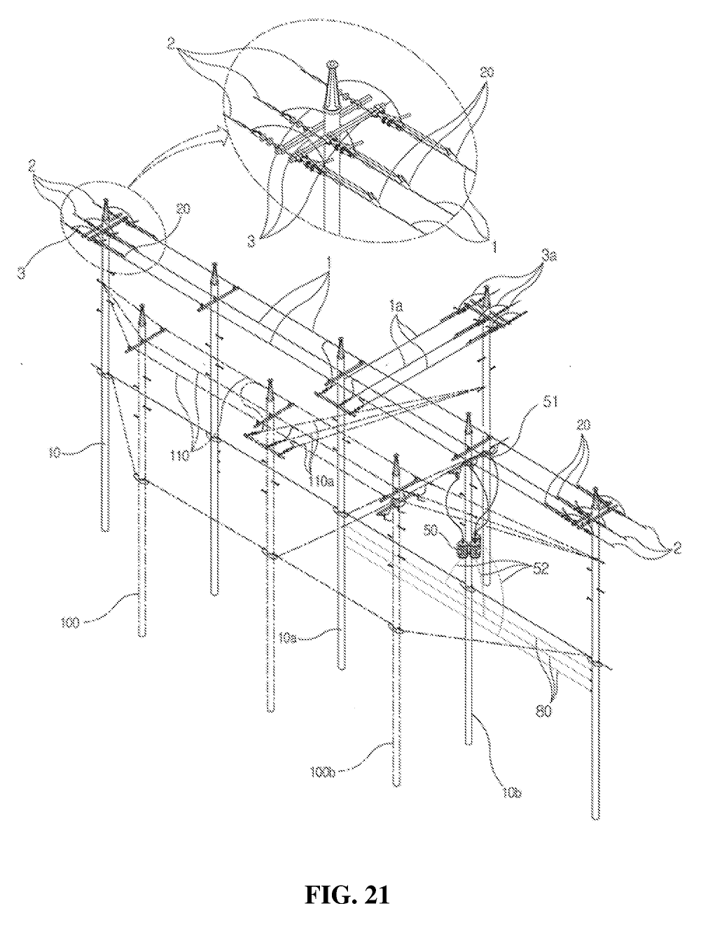

The case in which a branch-line electric pole 100a and an electric pole 10b having a pole-mounted transformer are present within a work section, as shown in FIG. 21

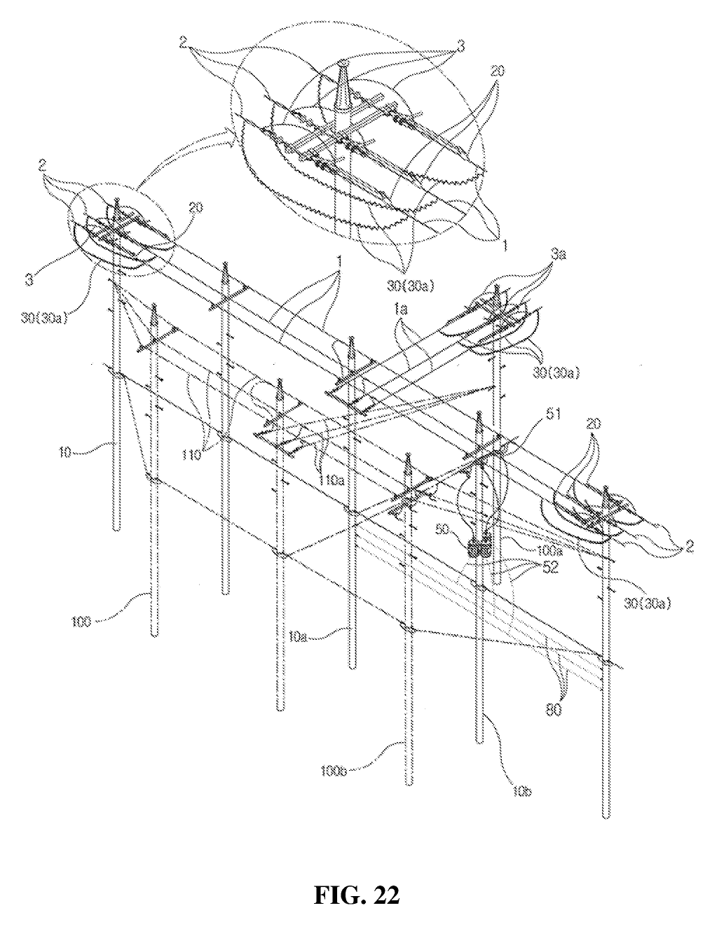

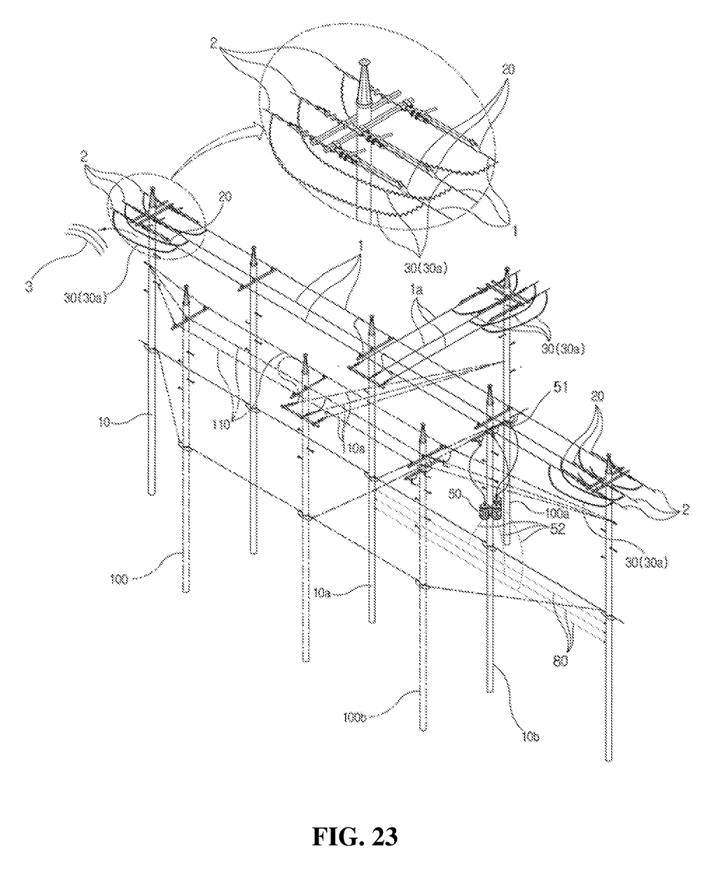

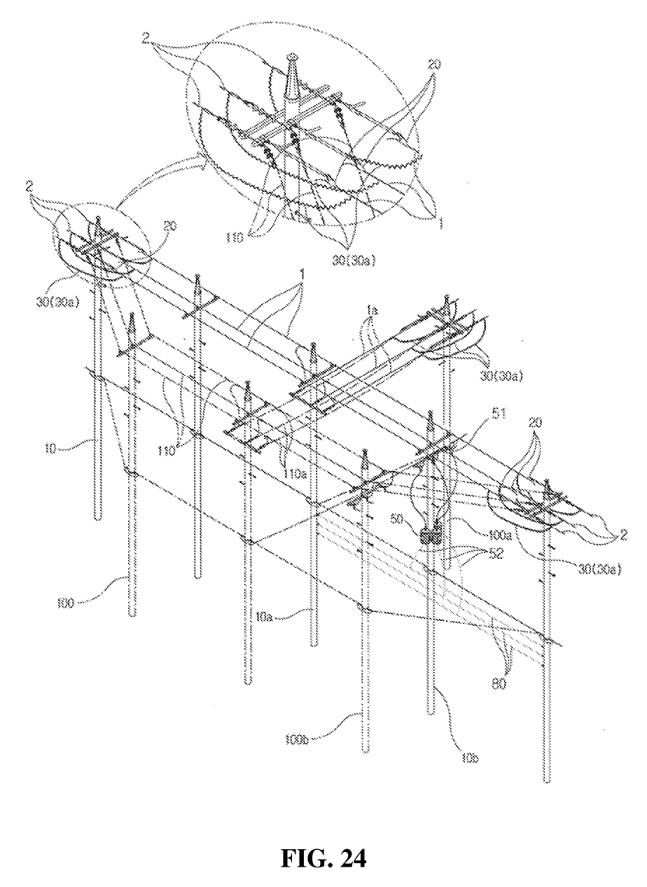

Electric-pole establishment work, electric-pole assembly work, and electric wiring work are performed within a work section in a dead-line state in order to perform uninterruptible preparation work, and, as shown in FIG. 22, electric wire clips of insulated live-line wire grips 20 for holding the tension of electric wires are installed inside a work section defined by a work-section start electric pole 10, a work-section end electric pole 10, and a branch-line electric pole 100a at points at which a safe dead-line work section of electric wires to be removed is secured. After the installation is completed, one end of a bypass jumper means 30 is connected to an electric wire outside each of the electric wire clips of the insulated live-line wire grips 20 within the work section span, and the other end of the bypass jumper means 30 is connected to an electric wire located outside each of the work-section start electric pole 10, the work-section end electric pole 10, and the branch-line electric pole 100a deviating from the work section, whereby bypass connection is completed. As shown in FIG. 23, jumper wires 3 of the work-section start electric pole 10, the work-section end electric pole 10, and the branch-line electric pole 100a are separated, and then, as shown in FIG. 24, an electric wire within the pole-to-pole span is separated from the point at which each of the electric wire clips of the insulated live-line wire grips 20 is held, whereby a safe dead-line work section is formed. Subsequently, the electric wire extending from the point of separation to a suspension insulator of each electric pole is removed in a dead-line state in order to remove an obstacle and to secure a safe dead-line work section in which newly established electric wires 110 and 110a are stretched and tensioned at the work-section start electric pole 10, the work-section end electric pole 10, and the branch-line electric pole 100a.

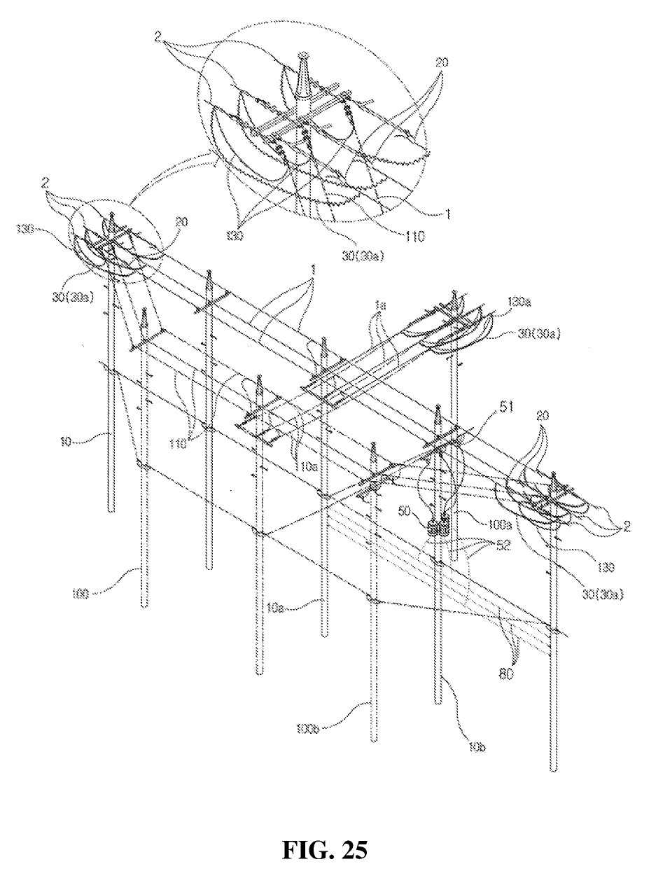

As shown in FIG. 25, newly established electric wires 110 and 110a are stretched, tensioned, and fixed in a dead-line state at the work-section start electric pole 10, the work-section end electric pole 10, and the branch-line electric pole 100a, and then jumper wires 130 of the newly established electric wires 110 and 110a, which have been stretched and tensioned at the work-section start electric pole 10, the work-section end electric pole 10, and the branch-line electric pole 100a, are sequentially connected to old electric wires 2 in a bypass fashion.

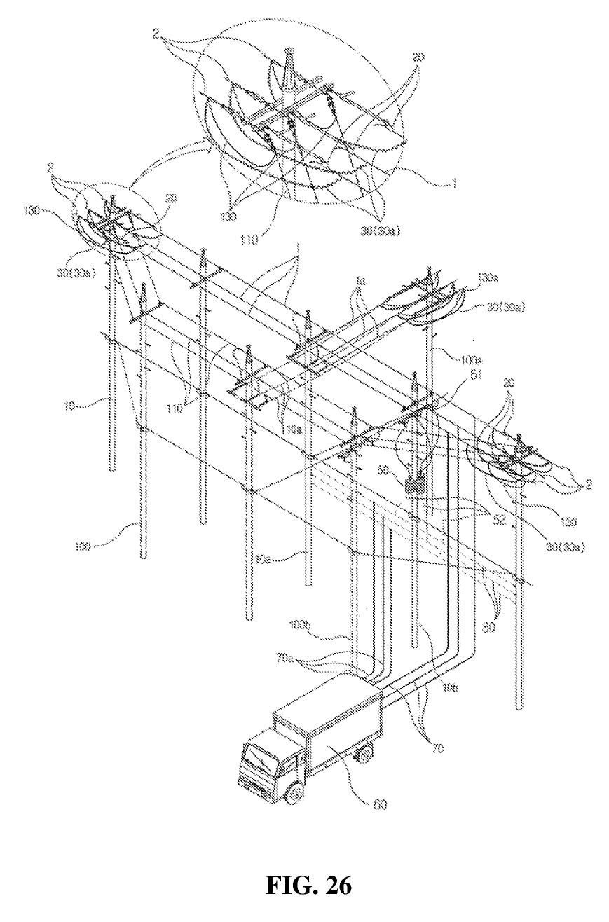

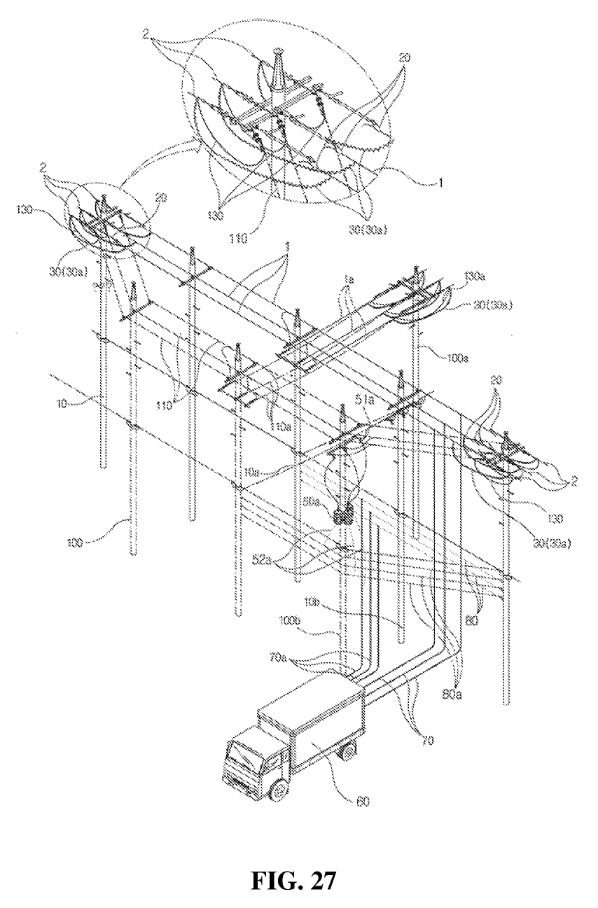

As shown in FIG. 26, an uninterruptible transformer apparatus 60 is installed at an electric pole 10b having a pole-mounted transformer within the work section, and a secondary low-voltage cable 70a is connected to a secondary low-voltage wire 80 of a pole-mounted transformer 50, whereby bypass connection is completed. Subsequently, a secondary drop wire 52 of the pole-mounted transformer 50 is separated, and a COS 51 of the pole-mounted transformer is opened. As shown in FIG. 27, the pole-mounted transformer 50 is removed and reused so as to be installed at a newly established electric pole 100b or a newly established pole-mounted transformer is installed at the newly established electric pole 100b, a COS 51a of the newly established pole-mounted transformer 50a is closed, a secondary drop wire 52a of the pole-mounted transformer 50a is connected, the uninterruptible transformer apparatus 60 is powered off, and a low-voltage cable 70a of the uninterruptible transformer apparatus 60 is separated, whereby the uninterruptible establishment and relocation of the transformer within the work section is completed.

In the case in which a plurality of electric poles each having a pole-mounted transformer is present within the work section, the process of replacing and relocating the pole-mounted transformer is repeatedly performed a number of times equal to the number of electric poles each having a pole-mounted transformer.

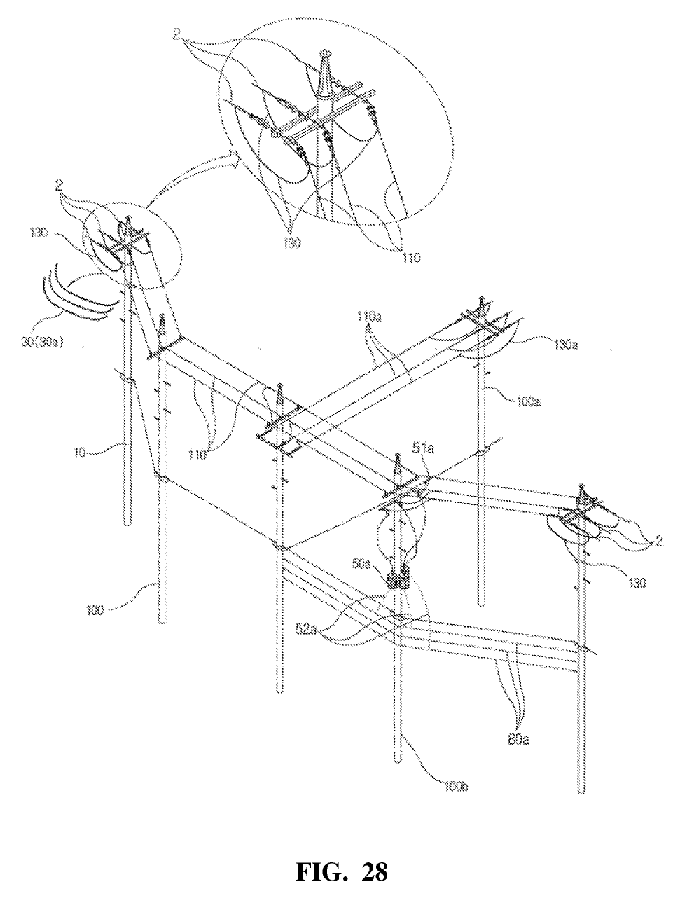

After the replacement and relocation of the pole-mounted transformers within the work section is completed, as shown in FIG. 28, bypass jumper means 30 installed at an electric pole between the work-section start electric pole 10 and the work-section end electric pole 10 and the branch-line electric pole 100a are sequentially separated, and electric wires 1 and 1a to be removed, the tension of each of which is held by a corresponding one of the electric wire clips of the insulated live-line wire grips, an electric pole corresponding thereto, and the uninterruptible transformer apparatus 60 are removed in a dead-line state, whereby it is possible to perform electric pole relocation work, electric pole replacement work, and electric pole route change work in an uninterruptible state in the case in which the branch-line electric pole 100a and the electric pole 10b having the pole-mounted transformer are present within the work section.

Meanwhile, when the uninterruptible power distribution method for performing the in-section work in the dead-line state by separating the electric wire within the pole-to-pole span using the insulated live-line wire grip and the bypass jumper wire according to the present invention is performed, the bypass jumper means 30, which connects the electric wire 1 to be removed and the old electric wire 2 to each other, is not limited, but is variously applicable.

First, referring to FIGS. 1 to 28, a bypass jumper cable 30a made of a single wire is applicable as the bypass jumper means 30. At this time, the bypass jumper cable 30a is capable of connecting an electric wire 1 to be removed and an old electric wire 2, each having three phases, to each other. During work, therefore, an electric wire to be removed and an old electric wire having one of the three phases may be individually connected to each other, or electric wires to be removed and old electric wires having the three phases may be simultaneously connected to each other.

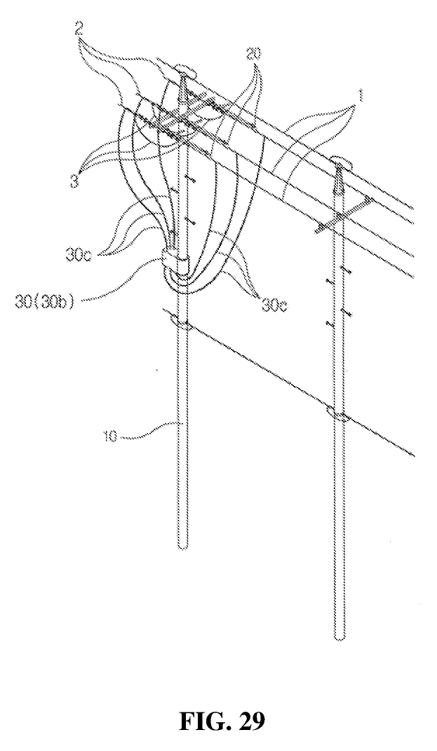

In addition, as shown in FIG. 29, a work switch 30b capable of simultaneously performing three-phase input and output is applicable as the bypass jumper means 30. At this time, an electric wire 1 to be removed having each of the three phases may be connected to the work switch 30b using a terminal cable 30c for the switch, and an old electric wire having each of the three phases may be connected to the work switch 30b using another terminal cable 30c for the switch. During work, therefore, an electric wire to be removed and an old electric wire having one of the three phases may be individually connected to each other, or electric wires to be removed and old electric wires having the three phases may be simultaneously connected to each other.

That is, in the case in which the work switch 30b is applied, the work switch 30b may be open for one phase, for which the work is performed, and may be closed for the other two phases when work based on a single phase is performed, although this is not shown in the figure. When work is simultaneously performed for three phases, the work switch 30b may be open for the three phases for which the work is performed.

1. An uninterruptible power distribution method for performing in-section work in a dead-line state by separating an electric wire within a pole-to-pole span using an insulated live-line wire grip and a bypass jumper wire,
the uninterruptible power distribution method being performed for electric pole relocation work, electric pole replacement work, and electric pole route change work in an uninterruptible state, wherein
the uninterruptible power distribution method comprises:
a process of performing electric-pole establishment work, electric-pole assembly work, and electric wiring work within a work section in the dead-line state in order to perform uninterruptible preparation work;
a process of installing electric wire clips of insulated live-line wire grips (20) for holding tension of electric wires inside a work section defined by a work-section start electric pole (10) and a work-section end electric pole (10) at points at which a safe dead-line work section of electric wires (1) to be removed is secured;
a process of connecting one end of a bypass jumper means 30 to an electric wire (1) to be removed outside each of the electric wire clips of the insulated live-line wire grips (20), installed within the work section defined by the work-section start electric pole (10) and the work-section end electric pole (10), and connecting the other end of the bypass jumper means (30) to an old electric wire (2) located outside each of the work-section start electric pole (10) and the work-section end electric pole (10) deviating from the work section, thereby completing bypass connection;
a process of sequentially separating jumper wires (3) of the work-section start electric pole (10) and the work-section end electric pole (10) and separating an electric wire (1) to be removed within a span of the electric poles (10) from a point at which each of the electric wire clips of the insulated live-line wire grips (20) is held;
a process of removing an electric wire (1) to be removed extending from a point of separation within a span of the work-section start electric pole (10) and the work-section end electric pole (10) to a suspension insulator of each electric pole (10) in order to secure a safe dead-line work space, and stretching, tensioning, and fixing newly established electric wires (110);
a process of sequentially connecting jumper wires (130) of the newly established electric wires (110), wired to the work-section start electric pole (10) and the work-section end electric pole (10), to the old electric wires (2) and separating the installed bypass jumper means (30); and
a process of removing the electric wires (1) to be removed, tension of each of which is held by a corresponding one of the electric wire clips of the insulated live-line wire grips (20), and an electric pole corresponding thereto.

2. An uninterruptible power distribution method for performing in-section work in a dead-line state by separating an electric wire within a pole-to-pole span using an insulated live-line wire grip and a bypass jumper wire,
the uninterruptible power distribution method being performed for electric pole relocation work, electric pole replacement work, and electric pole route change work in an uninterruptible state, wherein
in a case in which a branch-line electric pole (100a) is present within a work section,
the uninterruptible power distribution method comprises:
a process of performing electric-pole establishment work, electric-pole assembly work, and electric wiring work within the work section in the dead-line state in order to perform uninterruptible preparation work;
a process of installing electric wire clips of insulated live-line wire grips (20) for holding tension of electric wires inside a work section defined by a work-section start electric pole (10) and a work-section end electric pole (10), within which the branch-line electric pole (100a) is present, at points at which a safe dead-line work section of electric wires (1) to be removed is secured;
a process of connecting one end of a bypass jumper means (30) to an electric wire (1) to be removed outside each of the electric wire clips of the insulated live-line wire grips (20), installed at the work-section start electric pole (10) and the work-section end electric pole (10), and connecting the other end of the bypass jumper means (30) to an old electric wire (2) located outside each of the work-section start electric pole (10) and the work-section end electric pole (10) deviating from the work section, thereby completing bypass connection;
a process of sequentially separating jumper wires (3) of the work-section start electric pole (10) and the work-section end electric pole (10) and separating an electric wire (1) to be removed within a span of the electric poles (10) from a point at which each of the electric wire clips of the insulated live-line wire grips (20) is held;
a process of removing an electric wire (1) to be removed extending from a point of separation within a span of the work-section start electric pole (10) and the work-section end electric pole (10) to a suspension insulator of each electric pole (10) in order to secure a safe dead-line work space, and stretching, tensioning, and fixing newly established electric wires (110);
a process of installing electric wire clips of insulated live-line wire grips (20) for holding tension of electric wires inside a work section defined by the branch-line electric pole (100a) at points at which a safe dead-line work section of electric wires (1a) to be removed is secured;
a process of connecting one end of a bypass jumper means (30) to an electric wire (1a) to be removed outside each of the electric wire clips of the insulated live-line wire grips (20), installed at the branch-line electric pole (100a), and connecting the other end of the bypass jumper means (30) to an old electric wire (2) located outside the branch-line electric pole (100a) deviating from the work section, thereby completing bypass connection;
a process of sequentially separating jumper wires (3a) of the branch-line electric pole (100a) and separating an electric wire (1a) to be removed within a span of the branch-line electric pole (100a) from a point at which each of the electric wire clips of the insulated live-line wire grips (20) is held;
a process of removing an electric wire (1a) to be removed extending from a point of separation within the span of the branch-line electric pole (100a) to a suspension insulator of the branch-line electric pole (100a) in order to secure a safe dead-line work space, and stretching, tensioning, and fixing newly established electric wires (110a);
a process of sequentially connecting jumper wires (130) (130a) of the newly established electric wires (110) (110a), wired to the work-section start electric pole (10), the work-section end electric pole (10), and the branch-line electric pole (100a), to the old electric wires (2) (2a) and separating the installed bypass jumper means (30); and
a process of removing the electric wires (1) (1a) to be removed, tension of each of which is held by a corresponding one of the electric wire clips of the insulated live-line wire grips (20), and an electric pole corresponding thereto.

3. The uninterruptible power distribution method according to claim 2, wherein
in a case in which a plurality of branch lines is present within the work section,
in the process of installing the insulated live-line wire grips (20) at the branch-line electric pole (100a), the process of stretching, tensioning, and fixing newly established electric wires (110a) of the branch lines is repeatedly performed a number of times equal to a number of the branch lines.

4. An uninterruptible power distribution method for performing in-section work in a dead-line state by separating an electric wire within a pole-to-pole span using an insulated live-line wire grip and a bypass jumper wire,
the uninterruptible power distribution method being performed for electric pole relocation work, electric pole replacement work, and electric pole route change work in an uninterruptible state, wherein
in a case in which an electric pole (10b) having a pole-mounted transformer is present within a work section,
the uninterruptible power distribution method comprises:
a process of performing electric-pole establishment work, electric-pole assembly work, and electric wiring work within the work section in the dead-line state in order to perform uninterruptible preparation work;
a process of installing electric wire clips of insulated live-line wire grips (20) for holding tension of electric wires inside a work section defined by a work-section start electric pole (10) and a work-section end electric pole (10), within which the branch-line electric pole (100a) is present, at points at which a safe dead-line work section of electric wires (1) to be removed is secured;
a process of connecting one end of a bypass jumper means (30) to an electric wire (1) to be removed outside each of the electric wire clips of the insulated live-line wire grips (20), installed within the work section defined by the work-section start electric pole (10) and the work-section end electric pole (10), and connecting the other end of the bypass jumper means (30) to an old electric wire (2) located outside each of the work-section start electric pole (10) and the work-section end electric pole (10) deviating from the work section, thereby completing bypass connection;
a process of sequentially separating jumper wires (3) of the work-section start electric pole (10) and the work-section end electric pole (10) and separating an electric wire (1) to be removed within a span of the electric poles (10) from a point at which each of the electric wire clips of the insulated live-line wire grips (20) is held;
a process of removing an electric wire (1) to be removed extending from a point of separation within a span of the work-section start electric pole (10) and the work-section end electric pole (10) to a suspension insulator of each electric pole (10) in order to secure a safe dead-line work space, and stretching, tensioning, and fixing newly established electric wires (110);
a process of sequentially connecting jumper wires (130) of the newly established electric wires (110), wired to the work-section start electric pole (10) and the work-section end electric pole (10), to the old electric wires (2);
a process of installing an uninterruptible transformer apparatus (60) at the electric pole (10b) having the pole-mounted transformer within the work section, connecting a secondary low-voltage cable (70a) of the uninterruptible transformer apparatus (60) to a secondary low-voltage wire (80) of an installed pole-mounted transformer (50), thereby completing bypass connection, separating a secondary drop wire (52) of the pole-mounted transformer (50), opening a COS (51) of the pole-mounted transformer, and removing the pole-mounted transformer (50);
a process of installing the removed pole-mounted transformer at a newly established electric pole (100b) or installing a new pole-mounted transformer at the newly established electric pole (100b), closing a COS (51a) of a newly established pole-mounted transformer (50a), connecting a secondary drop wire (52a) of the pole-mounted transformer (50a), powering off the uninterruptible transformer apparatus (60), and separating a low-voltage cable (70a) of the uninterruptible transformer apparatus (60), thereby completing the replacement, establishment, and relocation of the pole-mounted transformer within the work section; and
a process of separating the bypass jumper means (30), installed at the work-section start electric pole (10) and the work-section end electric pole (10), and removing the electric wires (1) to be removed, the tension of each of which is held by a corresponding one of the electric wire clips of the insulated live-line wire grips within the section between the work-section start electric pole (10) and the work-section end electric pole (10), an electric pole corresponding thereto, and the uninterruptible transformer apparatus (60).

5. The uninterruptible power distribution method according to claim 4, wherein
in a case in which a plurality of electric poles (10b) each having a pole-mounted transformer is present within the work section,
in the process of installing the uninterruptible transformer apparatus (60) at the electric pole (10b) having the pole-mounted transformer,
the process of installing the removed pole-mounted transformer at the newly established electric pole (100b) or installing the new pole-mounted transformer at the newly established electric pole (100b) is repeatedly performed a number of times equal to a number of the electric poles (10b) each having the pole-mounted transformer.

6. An uninterruptible power distribution method for performing in-section work in a dead-line state by separating an electric wire within a pole-to-pole span using an insulated live-line wire grip and a bypass jumper wire,
the uninterruptible power distribution method being performed for electric pole relocation work, electric pole replacement work, and electric pole route change work in an uninterruptible state, wherein
in a case in which a branch-line electric pole (100a) and an electric pole (10b) having a pole-mounted transformer are present within a work section,
the uninterruptible power distribution method comprises:
a process of performing electric-pole establishment work, electric-pole assembly work, and electric wiring work within the work section in the dead-line state in order to perform uninterruptible preparation work;
a process of installing electric wire clips of insulated live-line wire grips (20) for holding tension of electric wires inside a work section defined by a work-section start electric pole (10) and a work-section end electric pole (10), within which the branch-line electric pole (100a) is present, at points at which a safe dead-line work section of electric wires (1) to be removed is secured;
a process of connecting one end of a bypass jumper means (30) to an electric wire (1) to be removed outside each of the electric wire clips of the insulated live-line wire grips (20), installed at the work-section start electric pole (10) and the work-section end electric pole (10), and connecting the other end of the bypass jumper means (30) to an old electric wire (2) located outside each of the work-section start electric pole (10) and the work-section end electric pole (10) deviating from the work section, thereby completing bypass connection;
a process of sequentially separating jumper wires (3) of the work-section start electric pole (10) and the work-section end electric pole (10) and separating an electric wire (1) to be removed within a span of the electric poles (10) from a point at which each of the electric wire clips of the insulated live-line wire grips (20) is held;
a process of removing an electric wire (1) to be removed extending from a point of separation within a span of the work-section start electric pole (10) and the work-section end electric pole (10) to a suspension insulator of each electric pole (10) in order to secure a safe dead-line work space, and stretching, tensioning, and fixing newly established electric wires (110);
a process of installing electric wire clips of insulated live-line wire grips (20) for holding tension of electric wires inside a work section defined by the branch-line electric pole (100a) at points at which a safe dead-line work section of electric wires (1a) to be removed is secured;
a process of connecting one end of a bypass jumper means (30) to an electric wire (1a) to be removed outside each of the electric wire clips of the insulated live-line wire grips (20), installed at the branch-line electric pole (100a), and connecting the other end of the bypass jumper means (30) to an old electric wire (2) located outside the branch-line electric pole (100a) deviating from the work section, thereby completing bypass connection;
a process of sequentially separating jumper wires (3a) of the branch-line electric pole (100a) and separating an electric wire (1a) to be removed within a span of the branch-line electric pole (100a) from a point at which each of the electric wire clips of the insulated live-line wire grips (20) is held;
a process of removing an electric wire (1a) to be removed extending from a point of separation within the span of the branch-line electric pole (100a) to a suspension insulator of the branch-line electric pole (100a) in order to secure a safe dead-line work space, and stretching, tensioning, and fixing newly established electric wires (110a);
a process of sequentially connecting jumper wires (130) (130a) of the newly established electric wires (110) (110a), wired to the work-section start electric pole (10), the work-section end electric pole (10), and the branch-line electric pole (100a), to the old electric wires (2) (2a);
a process of installing an uninterruptible transformer apparatus (60) at the electric pole (10b) having the pole-mounted transformer within the work section, connecting a secondary low-voltage cable (70a) of the uninterruptible transformer apparatus (60) to a secondary low-voltage wire (80) of an installed pole-mounted transformer (50), thereby completing bypass connection, separating a secondary drop wire (52) of the pole-mounted transformer (50), opening a COS (51) of the pole-mounted transformer, and removing the pole-mounted transformer (50);
a process of installing the removed pole-mounted transformer at a newly established electric pole (100b) or installing a new pole-mounted transformer at the newly established electric pole (100b), closing a COS (51a) of a newly established pole-mounted transformer (50a), connecting a secondary drop wire (52a) of the pole-mounted transformer (50a), powering off the uninterruptible transformer apparatus (60), and separating a low-voltage cable (70a) of the uninterruptible transformer apparatus (60), thereby completing the replacement and relocation of the pole-mounted transformer within the work section; and
a process of separating the bypass jumper means (30), installed at the work-section start electric pole (10), the work-section end electric pole (10), and the branch-line electric pole (100a), and removing the electric wires (1) (1a) to be removed, the tension of each of which is held by a corresponding one of the electric wire clips of the insulated live-line wire grips within the section between the work-section start electric pole (10), the work-section end electric pole (10) and the branch-line electric pole (100a), an electric pole corresponding thereto, and the uninterruptible transformer apparatus (60).

7. The uninterruptible power distribution method according to claim 1, wherein
a bypass jumper cable (30a) made of a single wire is applied as the bypass jumper means (30), in which case
the bypass jumper cable (30a) connects the electric wire (1) to be removed and the old electric wire (2), each having three phases, to each other, whereby
an electric wire to be removed and an old electric wire having one of the three phases are individually connected to each other, or electric wires to be removed and old electric wires having the three phases are simultaneously connected to each other, or wherein
a work switch (30b) capable of simultaneously performing three-phase opening and closing is applied as the bypass jumper means (30), in which case the electric wire (1) to be removed and the old electric wire (2) having each of the three phases are connected to each other via a terminal cable (30c) for the switch, which is connected to the work switch (30b), whereby
the work switch (30b) is individually opened and closed for each of the three phases or is simultaneously opened and closed for three phases.

8. The uninterruptible power distribution method according to claim 2, wherein
a bypass jumper cable (30a) made of a single wire is applied as the bypass jumper means (30), in which case
the bypass jumper cable (30a) connects the electric wire (1) to be removed and the old electric wire (2), each having three phases, to each other, whereby
an electric wire to be removed and an old electric wire having one of the three phases are individually connected to each other, or electric wires to be removed and old electric wires having the three phases are simultaneously connected to each other, or wherein
a work switch (30b) capable of simultaneously performing three-phase opening and closing is applied as the bypass jumper means (30), in which case the electric wire (1) to be removed and the old electric wire (2) having each of the three phases are connected to each other via a terminal cable (30c) for the switch, which is connected to the work switch (30b), whereby
the work switch (30b) is individually opened and closed for each of the three phases or is simultaneously opened and closed for three phases.

9. The uninterruptible power distribution method according to claim 4, wherein
a bypass jumper cable (30a) made of a single wire is applied as the bypass jumper means (30), in which case
the bypass jumper cable (30a) connects the electric wire (1) to be removed and the old electric wire (2), each having three phases, to each other, whereby
an electric wire to be removed and an old electric wire having one of the three phases are individually connected to each other, or electric wires to be removed and old electric wires having the three phases are simultaneously connected to each other, or wherein
a work switch (30b) capable of simultaneously performing three-phase opening and closing is applied as the bypass jumper means (30), in which case the electric wire (1) to be removed and the old electric wire (2) having each of the three phases are connected to each other via a terminal cable (30c) for the switch, which is connected to the work switch (30b), whereby
the work switch (30b) is individually opened and closed for each of the three phases or is simultaneously opened and closed for three phases.

10. The uninterruptible power distribution method according to claim 6, wherein
a bypass jumper cable (30a) made of a single wire is applied as the bypass jumper means (30), in which case
the bypass jumper cable (30a) connects the electric wire (1) to be removed and the old electric wire (2), each having three phases, to each other, whereby
an electric wire to be removed and an old electric wire having one of the three phases are individually connected to each other, or electric wires to be removed and old electric wires having the three phases are simultaneously connected to each other, or wherein
a work switch (30b) capable of simultaneously performing three-phase opening and closing is applied as the bypass jumper means (30), in which case
the electric wire (1) to be removed and the old electric wire (2) having each of the three phases are connected to each other via a terminal cable (30c) for the switch, which is connected to the work switch (30b), whereby
the work switch (30b) is individually opened and closed for each of the three phases or is simultaneously opened and closed for three phases.
